(19) United States
(12) Patent Application Publication
(10) Pub. No.: US 2025/0159532 A1
(43) Pub. Date: May 15, 2025

(54) METHOD AND APPARATUS FOR ARTIFICIAL INTELLIGENCE/MACHINE LEARNING BASED LIFE CYCLE MANAGEMENT (LCM)

(71) Applicant: Samsung Electronics Co., Ltd., Gyeonggi-do (KR)

(72) Inventors: Hamid SABER, San Diego, CA (US); Mohamed Mokhtar Gaber Moursi AWADIN, San Diego, CA (US); Yuan-Sheng CHENG, San Diego, CA (US); Jung Hyun BAE, San Diego, CA (US)

(21) Appl. No.: 18/944,794

(22) Filed: Nov. 12, 2024

Related U.S. Application Data
(60) Provisional application No. 63/598,488, filed on Nov. 13, 2023.
(60) Provisional application No. 63/549,939, filed on Feb. 5, 2024.
(60) Provisional application No. 63/676,703, filed on Jul. 29, 2024.

(51) Int. Cl. H04W 24/10; H04B 7/06; H04W 24/02

(52) U.S. Cl. CPC H04W 24/10; H04B 7/0626; H04W 24/02

(57) ABSTRACT

A system and a method are disclosed for AI/ML model LCM. A method performed by a UE includes transmitting, to a base station, a plurality of properties of supported functionalities for each of a plurality of AI/ML use cases, wherein each of the plurality of AI/ML use cases is configured with an individual use case ID; transmitting, to the base station, a maximum number of AI/ML active functionalities that the UE supports across the plurality of AI/ML use cases; receiving, from the based station, a report configuration based on the plurality of properties of supported functionalities for each of the plurality of AI/ML use cases and the maximum number of AI/ML active functionalities that the UE supports across the plurality of AI/ML use cases; generating a report based on the report configuration; and transmitting the report to the base station.

### CROSS-REFERENCE TO RELATED APPLICATION

This application claims the priority benefit under 35 U.S.C. § 119 (e) of U.S. Provisional Application Nos. 63/598,488, 63/549,939, and 63/676,703, which were filed on Nov. 13, 2023, Feb. 5, 2024, and Jul. 29, 2024, respectively, the disclosure of each of which is incorporated by reference in its entirety as if fully set forth herein.

### TECHNICAL FIELD

The disclosure generally relates to artificial intelligence/machine learning (AI/ML) model life cycle management (LCM). More particularly, the subject matter disclosed herein relates to improvements to methods and apparatuses for performing functionality-based LCM and model identity (ID)-based-LCM.

### SUMMARY

AI and ML techniques are used for inferring complex functions of data that are often difficult to obtain through other methods. A main idea behind such techniques is that many samples of data are provided to a learning-enabled device or machine, which in turn applies one of the various AI/ML techniques to learn how to determine those complex functions using the provided data samples.

In new radio (NR), from Rel-15 to 17, there is no AI/ML functionality that is specified in the specifications. AI/ML algorithms can be used as part of UE implementation without any specification impact. However, AI/ML can also be introduced and described in telecommunication standards, providing benefits of AI/ML at the system level.

A number of AI/ML use cases have been identified by telecommunication standards groups, such as channel state information (CSI) compression, CSI prediction, beam prediction in time domain (e.g., beam management (BM) case 1) or spatial domain (e.g., BM case 2), and positioning enhancement. Generally, CSI compression use cases requires a two-sided model, while other use cases work with a one-sided model.

Accordingly, a need exists for new specification support. Currently, inference complexity of running AI/ML models for different functionalities and AI/ML use cases is not ensured to be within UE capability with functionality based LCM.

Additionally, it is not currently possible to control performance monitoring at a UE side, such as how a performance monitoring CSI report is configured to a UE, how report content is described, how such a report is counted towards a CSI processing unit (CPU) capability, etc. For example, while CPUs may be used to reflect a complexity of CSI report calculations, it may not be sufficient to reflect the complexity of an AI/ML based CSI report.

Additionally, a UE may use a dedicated processing unit, e.g., neural processing unit, which differs from legacy operations. Also, different functionalities may use different AI/ML models

Therefore, enhancements are needed to reflect the complexity of an AI/ML based CSI report.

To overcome these and other issues, systems and methods are described herein for a UE and a gNB to perform AI/ML model LCM based on UE capability reports of supported functionalities and a gNB configuring functionalities to comply with UE capabilities.

Systems and methods are also described herein for maintaining UE complexity.

Systems and methods are also described herein for monitoring of inactive models.

Additionally, systems and methods are described herein for data collection by a UE based on RRC signaling, and UE capability. For example, indication of certain IDs during data collection may help a UE categorize a data set and train scenario specific models for enhanced performance.

In an embodiment, a method performed by a UE includes transmitting, to a base station, a plurality of properties of supported functionalities for each of a plurality of AI/ML use cases, wherein each of the plurality of AI/ML use cases is configured with an individual use case ID; transmitting, to the base station, a maximum number of AI/ML active functionalities that the UE supports across the plurality of AI/ML use cases; receiving, from the based station, a report configuration based on the plurality of properties of supported functionalities for each of the plurality of AI/ML use cases and the maximum number of AI/ML active functionalities that the UE supports across the plurality of AI/ML use cases; generating a report based on the report configuration; and transmitting the report to the base station.

In an embodiment, a UE includes a transceiver; and a processor configured to transmit, to a base station, via the transceiver, a plurality of properties of supported functionalities for each of a plurality of AI/ML use cases, wherein each of the plurality of AI/ML use cases is configured with an individual use case ID, transmit, to the base station, via the transceiver, a maximum number of AI/ML active functionalities that the UE supports across the plurality of AI/ML use cases, receive, from the based station, via the transceiver, a report configuration based on the plurality of properties of supported functionalities for each of the plurality of AI/ML use cases and the maximum number of AI/ML active functionalities that the UE supports across the plurality of AI/ML use cases, generate a report based on the report configuration, and transmit the report to the base station.

In an embodiment, a method performed by a base station includes receiving, from a UE, a plurality of properties of supported functionalities for each of a plurality of AI/ML use cases, wherein each of the plurality of AI/ML use cases is configured with an individual use case ID; receiving, from the UE, a maximum number of AI/ML active functionalities that the UE supports across the plurality of AI/ML use cases; generating a report configuration based on the plurality of properties of supported functionalities for each of the plurality of AI/ML use cases and the maximum number of AI/ML active functionalities that the UE supports across the plurality of AI/ML use cases; transmitting, to the UE, the report configuration; and receiving, from the UE, a report based on the report configuration.

### BRIEF DESCRIPTION OF THE DRAWING

In the following section, the aspects of the subject matter disclosed herein will be described with reference to exemplary embodiments illustrated in the figures, in which:

FIG. 1 illustrates an example of a P-CSI report associated with a particular functionality, according to an embodiment;

FIG. 2 illustrates an example of counting towards a limit of configured/active functionality when a functionality associated with a P-CSI report based on a reporting time, according to an embodiment;

FIG. 3 illustrates an example of counting towards a limit of a configured/active functionality when a functionality is associated with a semi-persistent (SP)-CSI report based on a functionality activation time, according to an embodiment;

FIG. 4 is a signal flow diagram, illustrating a procedure for establishing functionality-based LCM, according to an embodiment;

FIG. 5 illustrates an example of occupying AI/ML resources based on CPU framework, according to an embodiment;

FIG. 6 illustrates an example of occupying AI/ML resources based on when a report is configured/activated/triggered, according to an embodiment;

FIG. 7 illustrates an example of processing CSI reports deploying AI/ML mechanisms using the same AI/ML model, according to an embodiment;

FIG. 8 illustrates an example of switching time between CSI reports using different models, according to an embodiment;

FIG. 9 illustrates an example of relaxation of a processing timeline due to functionality or AI/ML model switching, according to an embodiment:

FIG. 10 illustrates an example of a CSI report occupying multiple AI/ML resources, according to an embodiment;

FIG. 11 illustrates an example of indicating AI/ML functionality associated with a P-CSI report, according to an embodiment;

FIG. 12 illustrates a timeline for applying an AI/ML functionality indicated via a MAC-CE, according to an embodiment;

FIG. 13 illustrates an example of fields of DCI or a MAC-CE indicating an AI/ML functionality and a corresponding CSI report, according to an embodiment;

FIG. 14 is a flow chart illustrated a method performed by a UE, according to an embodiment;

FIG. 15 is a flow chart illustrated a method performed by a base station, according to an embodiment;

FIG. 16 is a block diagram of an electronic device in a network environment, according to an embodiment; and

FIG. 17 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As described above, 3GPP Release 18 is currently exploring the potential of using AI/ML-based algorithms to enhance NR. An aspect of this exploration includes the development of a general AI/ML framework, alongside the exploration of specific use cases such as CSI feedback, beam management, and positioning.

Accordingly, an AI/ML model should be developed, deployed, and managed during the entire lifecycle—a process known as AI/ML model LCM.

A first method is categorized as functionality-based LCM. A functionality refers to an AI/ML-enabled feature or feature group facilitated by a configuration. AI/ML functionality identification provides mutual understanding between a network and a UE about the AI/ML functionality. The process of functionality identification may be integrated within the existing UE capability signaling framework. For example, configurations may be tailored in accordance with conditions indicated by UE capability. Subsequently, upon identifying functionalities, the UE can report updates pertaining to the applicable functionalities among those configured or identified. In functionality-based LCM, the network indicates selection, activation, deactivation, switch, and fallback of an AI/ML functionality through 3GPP signaling. However, the exact AI/ML model(s) that underpin a given functionality may not be identified at the network.

A second method is categorized as model ID-based-LCM. A model ID is a distinctive identifier for an AI/ML model, wherein the model could be logical and its mapping to a physical model is up to implementation. AI/ML model identification provides mutual understanding between the network and the UE concerning the AI/ML model in question. For example, the AI/ML model may be identified by its designated model ID at the network, and the UE indicates its supported AI/ML model to the network. Besides the model ID, the model can have accompanying conditions as part of the UE capability definition as well as additional conditions (e.g., scenarios, sites, and datasets) which determine the applicability of the model. In model-ID-based LCM, both the network and the UE may perform selection, activation, deactivation, switch, and fallback of an AI/ML model by using the corresponding model ID.

### Functionality-Based LCM

As described above, after a UE reports conditions to support AI/ML features to the network, e.g., a gNB, the gNB may configure M functionalities for the UE via radio resource control (RRC). Depending on UE implementation, the UE may have one model for each functionality, multiple models for the same functionality, or one model for multiple functionalities to perform inference. Since the UE AI/ML implementation complexity is closely related to the number of active/running models, or number of stored models, UE capability should be introduced to report conditions on the number of stored/active models. These capability reports may draw boundaries across which the UE is expected to run different models for inference.

In accordance with an embodiment, three schemes are described below for drawing the boundaries.

### Boundary Determination: Scheme 1

### UE Capability on a Number of Models/Functionalities

A UE may report its capability related to supported functionalities before functionality configuration. The UE may also report its capability related to configured functionalities to indicate to a gNB how the UE handles inference for each functionality. Herein, these processes may be referred to as a phase 1 report and a phase 2 report, respectively.

Phase 1: UE capability report before functionality configuration:

In this phase, the UE reports properties of a configured functionality for it to be supported by the UE. Any functionality configured by the gNB that does not meet these requirements are not supported by the UE. For example, the UE may declare its capability as a certain sizes or maximum sizes for set A and B for the case of beam management, or certain properties such as the length of the window for CSI prediction use case and so on. For example, if the UE declares that it only supports a set A size of 4, any functionality configuration in which the size of the set A is not 4 is not supported. This phase of the report indicates to the gNB what conditions a functionality configuration must meet to be supported by the UE (i.e., feasible functionalities), but does not indicate any restriction on the number of configured/active functionalities UE requires.

In addition to the aforementioned reports, the UE may also report supported conditions regarding the number of functionalities as follows.
The UE reports a maximum number of functionalities that the gNB can configure for the UE.
For each AI/ML use case, the UE reports the maximum number of functionalities that the gNB can configure for the UE. For example, UE reports:
   X_{config,1} for CSI compression, X_{config,2} for CSI prediction (or one value for the entire CSI feedback feature), X_{config,3} for beam prediction in time domain, X_{config,4} for beam prediction in spatial domain (or one value for the entire beam prediction feature), etc.
If N AI/ML uses cases are identified in the specification, since the models developed for different use cases may entail different inference/storage complexity levels, it may be beneficial for the UE to report per use case maximum number of functionalities and the total number of functionalities. That is, the UE reports X_{config,i}, i=1, . . . , N, as the maixmum number of functionalities that the gNB can configure for the use case i, and the total number of functionalities across all use cases X_{config,total}. Therefore, if the gNB configures nᵢ functionalities for the use case i, it should satisfy Equation (1):

$$\{ {n}_{i} \leq {X}_{config , i} for i = 1 , … , N , {\sum }_{i = 1}^{N} {n}_{i} \leq {X}_{config , total} \qquad ( 1 )$$

The UE may also report a maximum number of active (simultaneous) running models that the UE supports in an inference phase. Herein, X_{active,i} is used to represent the maximum number of active (simultaneous) running models that the UE supports in the inference phase for use case #i, and X_{active,total} is used to represent the maximum number of active (simultaneous) running models that the UE supports in the inference phase, i.e., a total number, across all use cases. Therefore, if the gNB activates nᵢ functionalities for the use case i, it should satisfy Equation (2):

$$\{ {n}_{i} \leq {X}_{active , i} for i = 1 , … , N , {\sum }_{i = 1}^{N} {n}_{i} \leq {X}_{active , total} \qquad ( 2 )$$

The counting of the number of active (simultaneous) running models or number of configured functionalities may performed within a certain window in the time domain. The time window may depend on the type of CSI report associated with the functionality.

For a functionality associated with a periodic (P)-CSI report, counting towards the limit may occur from the instance of activating the functionality until its deactivation.

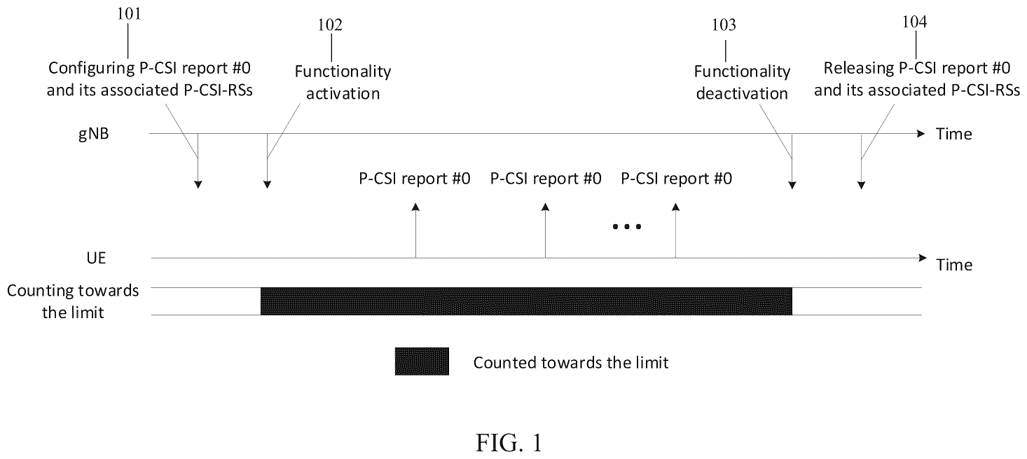

FIG. 1 illustrates an example of a P-CSI report associated with a particular functionality, according to an embodiment. More specifically, FIG. 1 illustrates a procedure of counting towards a limit of a configured/active functionality when a functionality is associated with a P-CSI report based on a functionality activation time.

Referring to FIG. 1, where the UE separately receives a configuration of a P-CSI report 101 and functionality activation 102, in a time window before receiving the functionality activation 102 after P-CSI configurations 101, and in the time window after receiving the functionality deactivation 103 before P-CSR release 104, one of the following may be applied:
The UE may ignore the configuration P-CSI association with the functionality until it is activated, e.g., the UE does not report and does not measure associated reference signals (RSs).
The UE may apply legacy CSI reporting, i.e., ignore the configurations related to AI/ML, until the functionality is activated.

Although FIG. 1 illustrates the configurations of P-CSI report 101 and functionality activation 102 being separately transmitted, they may be transmitted together. For example, both of them may be transmitted via RRC.

Alternatively, the counting towards the limit may be similar to legacy CPU occupation time.

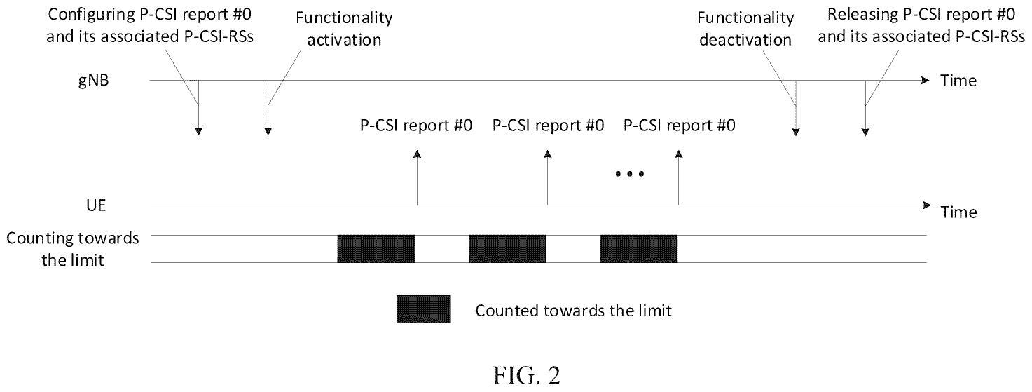

FIG. 2 illustrates an example of counting towards a limit of configured/active functionality when a functionality associated with a P-CSI report based on a reporting time, according to an embodiment.

More specifically, FIG. 2 illustrates counting towards a limit from a first symbol of an earliest one of each CSI-RS/CSI-IM/SSB resource for channel or interference measurement, respective latest CSI-RS/CSI-IM/SSB occasion no later than the corresponding CSI reference resource, until a last symbol of a configured physical uplink shared channel (PUSCH)/physical uplink control channel (PUCCH) carrying the P-CSI report. The window during which the functionality is counted is defined from a starting point to an end of a last symbol of an uplink channel carrying a CSI report. The starting point is an earliest RS from an RS set associated with a report with a condition that the RS is before a CSI reference resource which is in a defined slot.

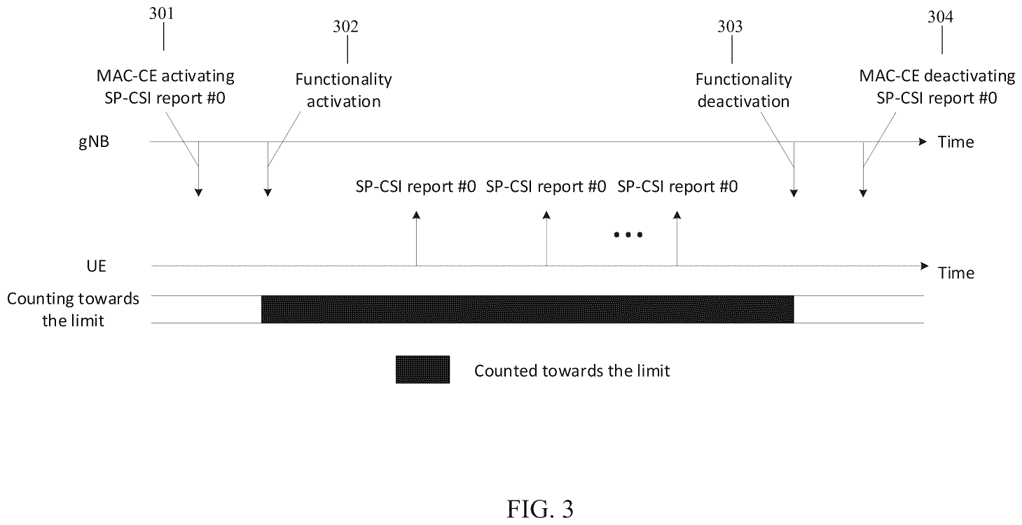

FIG. 3 illustrates an example of counting towards a limit of a configured/active functionality when a functionality is associated with a semi-persistent (SP)-CSI report based on a functionality activation time, according to an embodiment.

Referring to FIG. 3, an SP-CSI report is activated by media access control (MAC)-control element (CE) 301 and then an associated AI/ML functionality is activated 302. Although FIG. 3 illustrates two separate steps for activating an SP-CSI report 301 and activating the associated functionality 302, as well as deactivating an SP-CSI report 304 and deactivating the associated functionality 303, both of them may be carried in the same signal. For example, the same MAC-CE may be used to activate or deactivate both an SP-CSI report and the associated functionality. Similar to P-CSI reporting, in a time window before receiving the functionality activation 302 after SP-CSI activation 301 is applied, and in a time window after receiving the functionality deactivation 303 before SP-CSI deactivation 304 is applied, one of the following may be applied:
The UE may ignore the configuration SP-CSI association with the functionality until it is activated, e.g., the UE does not report and does not measure the associated RSs.
The UE may apply legacy CSI reporting, i.e., ignore the configurations related to AI/ML, until the functionality is activated.

As illustrated in FIG. 3, the counting towards the limit may occur from the instance of activating the functionality 302 until its deactivation 303.

Alternatively, the counting towards the limit may be similar to legacy CPU occupation time.

Phase 2: UE capability report after functionality configuration:

For example, a gNB configures a UE with M functionalities. The UE may report its capability to perform inference for the functionalities. The following are the possibilities.
Multiple models for a functionality: The UE may report, to the gNB, that it has two models for a configured functionality. For example, the UE may have one model for low Doppler and one for high Doppler.
   For such a UE, the gNB may relax the processing time for reporting an inference result to the gNB. A justification could be that the UE may need to switch models depending on the scenario discovery. For example, if the UE detects that the Doppler has changed from low to high, the UE may need to switch models, which may require some extra time. The UE may report a relaxation time as a UE capability report in this case, e.g., a number of symbols d with a reference subcarrier spacing (SCS).
One model for a group of functionalities: The UE may also indicate, to the gNB, that the UE uses a single model to perform an inference for a group of functionalities. This may be possible due to a specific type of training where the UE trains a model for different scenarios. For example, if the UE trains a single model for two possibilities of (set A, set B), or two possibilities of (#of observed CSI-RS, #of predicted CSIs), and the gNB configures two functionalities each for one of the choices, the UE may group the two functionalities and report its capability to run a single model for the two functionalities. Regarding the signaling, if the UE is configured with N functionalities, UE may report a bitmap of length N for each group to indicate which functionalities are included in a group. The UE may report more than one group of functionalities.
   the gNB switches the functionality within a group, no switching processing time may be needed.
   If the gNB switches the functionality from one group to a different group, a switching processing time may need to be provided to the UE in order to perform model switching
      The two sub-bullets above assume that every two groups of functionalities in the UE report are disjointed. In accordance with an embodiment, the UE may not be expected to report groups that are not disjointed. In accordance with another embodiment, if the UE reports such groups, a union is considered as one group.
No report: If the UE does not report according to Multiple models for a functionality or One model for a group of functionalities, as described above, it implies that the UE runs a separate model for each functionality. The gNB should provide sufficient processing time when the UE switches from one functionality to another, similar to switching from one group to another in One model for a group of functionalities.

After the gNB activates functionalities, the number of activated functionalities may be calculated considering what the UE reports in phase 2. For example, if the gNB activates functionality 1 for which the UE reports two models, the activated functionality is counted twice. Similarly, if the gNB activates one or more functionalities from a set for which the UE reported to use only one model, regardless of the number of activated functionalities from the set, one functionality is counted for all of the activated functionalities. For example, supposing that 4 functionalities are configured, the UE may then declare that it has two models for functionality #1and one model for a set of functionalities 2, 3, and 4. If the gNB activates all 4 functionalities, the count is 1+1=2, and may not be greater than X_{active,total}.

### Boundary Determination: Scheme 2

An alternative to consider UE constraints on the number of models and inference complexity with functionality-based LCM is that the UE defines, in UE capability reports, conditions under which the UE can perform AI/ML inference with a single model. In other words, the UE draws boundaries within which model can be used, regardless of the number of configured functionalities within the boundary. Herein, these conditions may be referred to as “boundary conditions”.

For example, for a beam management (BM) case1, boundary conditions, as shown in Table 1, can be declared by the UE.

TABLE 1

| | |
|---|---|
| Boundary | Set A, B such that the size of set A and B is within |
| condition #1 | range #1: \|B\| ≤ Y₁, \|A\| ≤ Z₁ |
| Boundary | Set A, B such that the size of set A and B is within |
| condition #2 | range #1: Y₁ < \|B\| ≤ Y₂, Z₁ < \|A\| ≤ Z₂ |
| Boundary | Set A, B such that the size of set A and B is within |
| condition #3 | range #1: Y₂ < \|B\| ≤ Y₃, Z₂ < \|A\| ≤ Z₃ |

Based on this capability report, the gNB configures functionalities such that each functionality is within one boundary condition. For example, the gNB can configure one or multiple functionalities with sets A and B, such that for each functionality |B|≤Y₁, |A|≤Z₁. The gNB will know how many different models the UE would need to run for a set of configured functionalities based on the indicated boundary conditions; the UE uses a single model for all the functionalities within one boundary condition.

A configured functionality should satisfy one and only one boundary condition. Further, the gNB cannot configure a functionality that does not satisfy any of the boundary conditions. For example, a functionality with |B|≤Y₁ and |A|>Z₁ is not allowed.

Similar to scheme 1, the number of configured or activated functionalities should satisfy the maximum number given by X_{configur,total} and X_{active,total}, with a modification in counting the number of functionalities, i.e., all of the configured functionalities within one boundary condition are counted only once.

Alternatively, since a UE may run multiple models for different additional conditions within a boundary condition, the UE can also report a number a for each boundary such that all the configured functionalities within a boundary region are counted α times towards the limit. For example, the UE can report that all functionalities configured within boundary condition #1 are counted as 2 (α=2) for handling two gNB beam codebook additional conditions or two Doppler spread levels (e.g., low and high).

The UE may also include additional conditions in the boundary conditions in the form of an ID. The UE may also include unknown additional conditions such as Doppler level. An example is shown below in Table 2.

TABLE 2

| | |
|---|---|
| Boundary | Set A, B such that the size of set A and B is within |
| condition #1 | range #1: \|B\| ≤ Y₁, \|A\| ≤ Z₁, High Doppler |
| Boundary | Set A, B such that the size of set A and B is within |
| condition #2 | range #1: \|B\| ≤ Y₁, \|A\| ≤ Z₁, Low Doppler |
| Boundary | Set A, B such that the size of set A and B is within |
| condition #3 | range #1: Y₁ < \|B\| ≤ Y₂, Z₁ < \|A\| ≤ Z₂, High Doppler |
| Boundary | Set A, B such that the size of set A and B is within |
| condition #4 | range #1: Y₁ < \|B\| ≤ Y₂, Z₁ < \|A\| ≤ Z₂, Low Doppler |
| Boundary | Set A, B such that the size of set A and B is within |
| condition #5 | range #1: Y₂ < \|B\| ≤ Y₃, Z₂ < \|A\| ≤ Z₃, High Doppler |
| Boundary | Set A, B such that the size of set A and B is within |
| condition #6 | range #1: Y₂ < \|B\| ≤ Y₃, Z₂ < \|A\| ≤ Z₃, Low Doppler |

Since the additional condition is only known at the UE, if the gNB configures/activates a functionality, the functionality is counted twice towards the number of configured/activated functionalities.

After the boundaries are defined and indicated to the gNB (or specified in the specification in advance, as in scheme 3 below), a specific UE implementation may not support certain combinations of the boundaries. For example, a UE may support a functionality configuration within boundary #i and boundary #j, individually, but not simultaneously.

In accordance with an embodiment, the UE may declare an additional UE capability on the supported combinations of the boundary conditions. To this end, the UE may report a bitmap of length N, when N boundary conditions are determined. For example, a value of “0” means the boundary condition is not supported while “1” indicates support.

Furthermore, the bitmap may indicate the combination, i.e., the simultaneous support of the boundaries. For example, if the UE reports (1,0,1,1), it indicates the support of simultaneous configuration of the boundaries 1, 3, and 4.

The UE may also report supported combinations in different way. For example, the UE may report boundary conditions that cannot be configured/activated simultaneously, e.g., it does not support of simultaneous configuration/activation of functionalities in boundary condition 1 and 2.

### Boundary Determination: Scheme 3

In this scheme, boundaries may be defined in a similar way as scheme 2, except that the boundaries are defined in 3GPP specification without any signaling from the UE. That is, in scheme 2, the boundary conditions are defined/declared by the UE by capability signaling, but in scheme 3, the boundaries are predefined in the specification and already known to both the UE and the gNB.

### Boundary Determination Based on CSI Report: Scheme 4

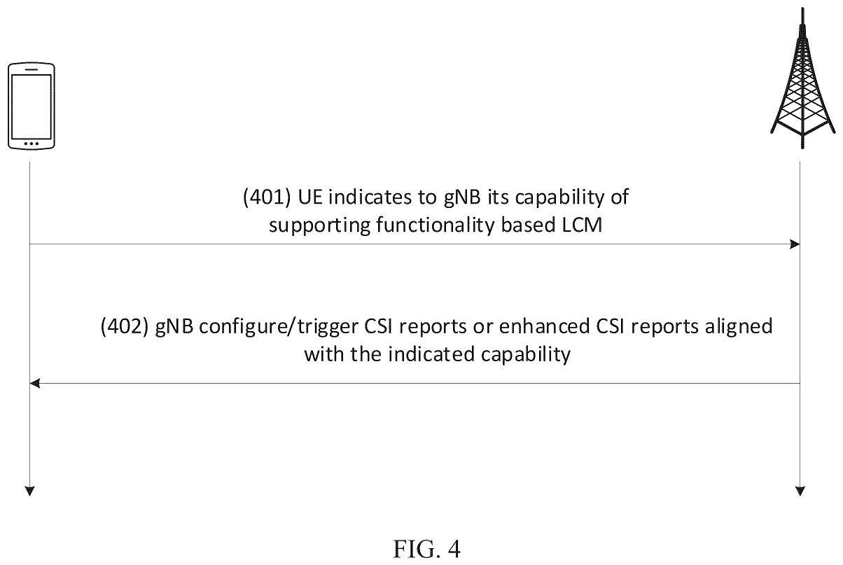

FIG. 4 is a signal flow diagram, illustrating a procedure for establishing functionality-based LCM, according to an embodiment. More specifically, FIG. 4 shows an alternative of functionality-based LCM.

Referring to FIG. 4, in step 401, a UE indicates, to a gNB, conditions and/or additional conditions allowing the UE to use its AI/ML model. The conditions and/or the additional conditions may depend on the use case, CSI compression/prediction, temporal beam management, or spatial beam management.

In step 402, the gNB configures/triggers CSI reports or enhanced versions that are compatible with the indicated UE capabilities.

Table 3 below shows an example of a set of functionalities that the UE can support, which may be carried via UE capability signaling. For a spatial beam prediction use case, the UE may indicate, to the gNB, the supported sizes of set A and set B. The UE may additionally signal the supported association types between set A and set B, e.g., indicate whether set B is a subset of set A, or set B is not necessarily a subset of set A (e.g., set B includes wide beams while set A includes narrow beams).

Furthermore, the UE may support functionality for particular types of CSI reports and RSs. For example, the AI/ML may be supported for periodic RSs and P-CSI reports, and/or periodic RSs and SP-CSI reports, but may not be supported for periodic RSs and aperiodic (AP)-CSI reports.

For a temporal beam prediction use case, in addition to the indicated capabilities for spatial beam prediction, the UE may indicate minimum requirements on an observation window and a prediction window.

Moreover, for CSI prediction, the UE may indicate a supported number of CSI subbands, and the types of the reports and RSs as being periodic, semi-persistent, or aperiodic.

For a functionality indicated, to the gNB, from UE, via capability signaling, the same AI/ML model may be used for all the CSI reports associated with this functionality. However, different AI/ML models may be deployed for CSI reports associated with different functionalities.

TABLE 3
Functionality-based LCM

Spatial beam prediction: Size of set A (x1), size of set B (y1), the
association between set A and set B, the CSI report type (P/SP/AP),
the RS type (P/SP/AP), etc.
Spatial beam prediction: Size of set A (x2), size of set B (y2), the
association between set A and set B, the CSI report type (P/SP/AP),
the RS type (P/SP/AP), etc.
Temporal beam prediction: Size of set A (x3), size of set B (y3),
the association between set A and set B, the observation window,
the prediction window, the CSI report type (P/SP/AP), the RS type
(P/SP/AP), etc.
CSI prediction: The number of CSI subbands, report type (P/SP/AP),
the RS type (P/SP/AP), etc.
. . .

When the gNB receives the UE's capabilities indications, the gNB may configure the UE with the proper CSI reports or enhanced CSI reports that match the indicated capabilities. For example, in case of spatial domain beam prediction, the configuration of the reports or the associated RSs may include information about the set A that may be defined by a set of RSs IDs, a set ID, etc. Alternatively, multiple sets of set A may be predefined, e.g., provided in the specification, and the gNB indicates the applicable one as part of the configuration of a report or associated RSs. Similarly, set B may be configured in the form of a set of RSs IDs, a set ID, etc., or it may be predefined, e.g., provided in the specification, and the gNB indicates the applicable one as part of the configuration of the report or the associated RSs.

The indicated set A and set B have the same relation as indicated by the UE capability, e.g., set B is a subset of set A or set B is not a subset of set A (set B is wide beams compared with narrow beams of set A). Once such configurations are provided to the UE, the UE applies the AI/ML associated with this functionality.

The aforementioned schemes for determining whether the same or different model is used for a particular functionality may also be applied across configured/triggered CSI reports deploying AI/ML mechanisms. Additionally, indicating or predefining boundary lines for functionalities that use the same model may also be applied on configured/triggered CSI reports deploying AI/ML mechanisms. In other words, the term ‘functionality’ may be replaced with ‘CSI report deploying AI/ML mechanisms’.

For example, the UE may indicate, to the gNB, a maximum number of simultaneous CSI reports deploying AI/ML mechanisms for beam management using AI/ML per component carrier (CC) or/and across all CCs, e.g., X_{active,i}, i is an index corresponding to the use case. Moreover, the UE may indicate the maximum number of simultaneous CSI reports deploying AI/ML mechanisms using AI/ML across all use cases per CC or/and across all CCs, X_{active,total}. That is, X_{active,i} and X_{active,total} may be considered as the maximum number of CSI reports using distinct AI/ML models/functionality that can be processed concurrently.

To determine when and for how long a particular CSI report deploying AI/ML occupies AI/ML resources from the indicated limits of AI/ML capabilities, legacy CPU framework may be used as a baseline.

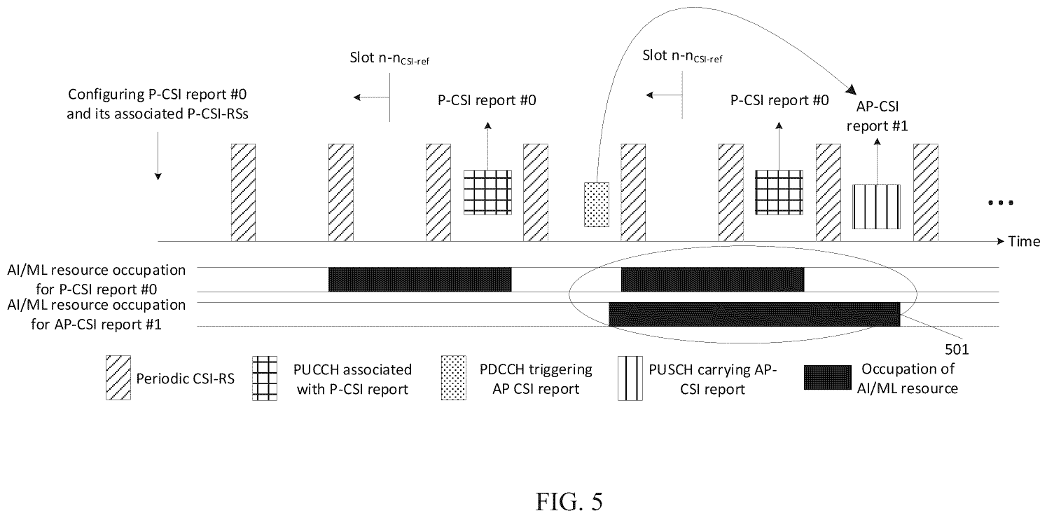

FIG. 5 illustrates an example of occupying AI/ML resources based on CPU framework, according to an embodiment. More specifically, FIG. 5 shows an example of a P-CSI-RS associated with two CSI reports deploying AI/ML mechanisms, i.e., P-CSI report #0 and AP-CSI report #1, which may deploy different AI/ML mechanisms.

Referring to FIG. 5, in time duration 501, the UE utilizes two AI/ML resources to be able to simultaneously calculate the CSI report or perform inference according to the use case. For example, for a P-CSI report, the AI/ML resource is occupied from the first symbol of the earliest one of each CSI-RS/CSI-IM/SSB resource for channel or interference measurement, respective latest CSI-RS/CSI-IM/SSB occasion no later than the corresponding CSI reference resource, until the last symbol of the configured PUSCH/PUCCH carrying the report.

For an AP-CSI report, the AI/ML resource is occupied from the first symbol after the PDCCH triggering the CSI report until the last symbol of the scheduled PUSCH carrying the report. If the UE indicates X_{active,i} or X_{active,total} is equal to two or more, the UE may be able to support the operation exemplified in FIG. 5 at time duration 501 and perform inference for two reports.

Instead of using CPU framework, the occupation of the AI/ML may be based on when the CSI report deploying AI/ML mechanisms is configured/triggered. For example, for a P-CSI report deploying AI/ML mechanisms, the AI/ML resource may be occupied from the instance the report is configured until it is released.

For an SP-CSI report, the AI/ML resource may be occupied from the instance when the activation command is applied until the deactivation command is applied.

For an AP-CSI report, the AI/ML resource may be occupied from the end of the PDCCH containing the request and ending at the end of the scheduled PUSCH containing the report associated with this aperiodic CSI-RS.

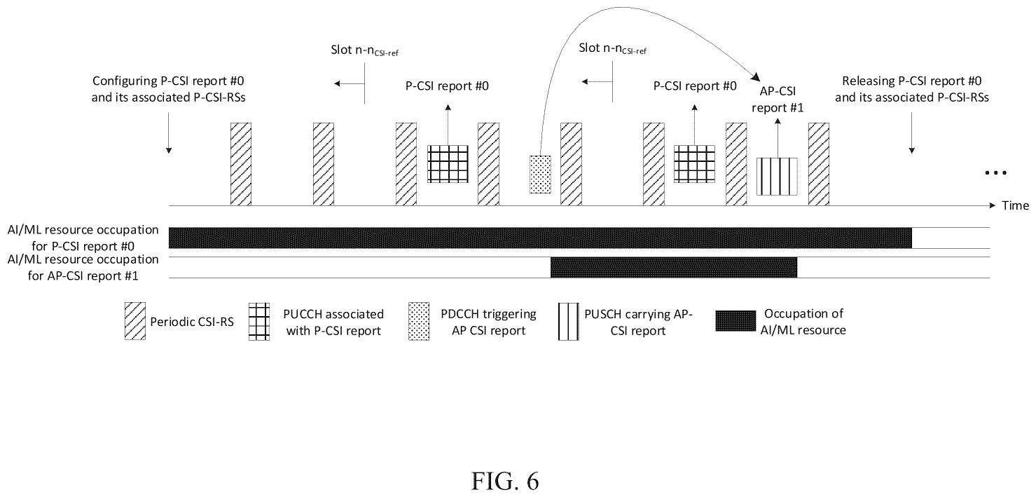

FIG. 6 illustrates an example of occupying AI/ML resources based on when a report is configured/activated/triggered, according to an embodiment. Compared with FIG. 5, FIG. 6 shows an example that the AI/ML resource is occupied from the time a CSI report is configured/activated/triggered until the CSI report is released/deactivated/submitted.

Referring to FIG. 6, the occupied AI/ML resource for AP CSI report is similar to the one illustrated in FIG. 5. On the other hand, for P-CSI reporting, the AI/ML resource is occupied from the time it is configured until it is released. This may be justifiable as the UE may need to buffer the AI/ML model and store the corresponding parameter once the CSI report is configured/activated/triggered.

As another option, although the UE may indicate or the gNB may determine that the same AI/ML model is to be used for multiple CSI reports deploying AI/ML mechanism, e.g., as explained in schemes 1, 2, and 3 above, the UE may not be able to use the same AI/ML model for processing multiple reports simultaneously. In other words, even though multiple CSI reports use the same AI/ML model and switching between them may not require additional delay, the UE may not be able to run them simultaneously. Therefore, the UE may indicate, via capability signaling X_{active within a model}, to the gNB, a maximum number of CSI reports, e.g., X_{active within a model}, that can be processed simultaneously, even when the same AI/ML model is used for this set of CSI reports, e.g., falling within a boundary condition.

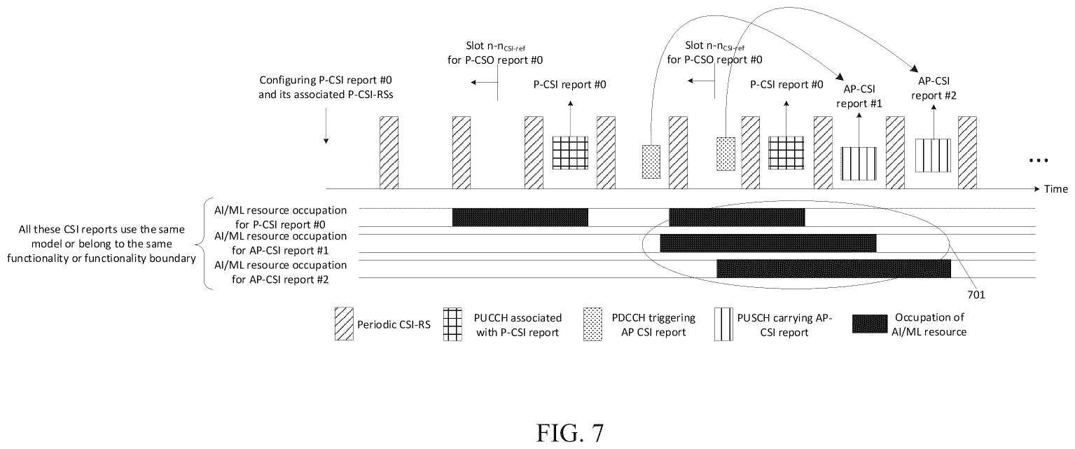

FIG. 7 illustrates an example of processing CSI reports deploying AI/ML mechanisms using the same AI/ML model, according to an embodiment. More specifically, FIG. 7 shows an example of a UE indicating capability of that, for a set CSI reports using the same AI/ML model, within the same functionality, e.g., within the same side of the boundary as described in scheme 2 or 3 above, the AI/ML resources may be occupied twice concurrently, i.e., X_{active within a model}=2.

Referring to FIG. 7, P-CSI report #0, AP-CSI report #1, and AP-CSI report #2 belong to the same set of CSI reports that can be processed by the same AI/ML model. In the time duration of 701, the UE may be required to process three CSI reports with the same set of CSI reports exceeding the indicated capability. To address this situation, any of the following options or their combination may be applied.
The UE may consider it as an error case, i.e., the UE does not expect to be requested to process CSI reports with the same set exceeding the indicated capability via UE capability or predefined, e.g., provided in the specification. Alternatively, this error case may be applied to the AP-CSI report within the same set. In other words, the UE may not expect the gNB to trigger an AP-CSI report deploying AI/ML mechanisms that result in exceeding such limit.
The UE may use some rule to drop/not to update the CSI report deploying AI/ML mechanisms within the same set. The rule may be based on a report ID, CC ID, or using a priority calculation equation.
Rather than dropping/not updating the report, the UE may apply legacy CSI calculations, e.g., non-AI/ML based mechanisms, and ignore the configurations related to AI/ML

Although the example in FIG. 7 shows that AI/ML resources are occupied based on legacy CPU framework, embodiments of the disclosure may also be applied when AI/ML resources are occupied based on when a report is configured/activated/triggered.

For a set of CSI reports that is determined according to some rules, e.g., falling within one side of the boundary in scheme 2 or 3, or indicated by the UE, e.g., as described in scheme 1, to use the same AI/ML model or belong to the same functionality, the UE may switch between them without additional timeline.

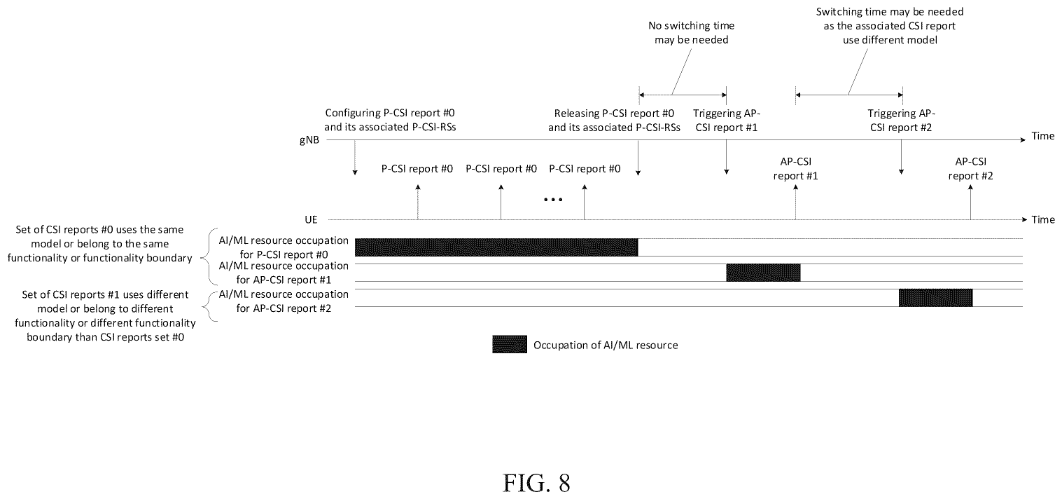

FIG. 8 illustrates an example of switching time between CSI reports using different models, according to an embodiment.

Referring to FIG. 8, two sets of CSI reports are provided, i.e., set #0 and set 1, where CSI reports associated with set #0 that use the same AI/ML model, belong to the same functionality, falling within one side of the boundary as in scheme 2 or 3, or indicated by the UE, e.g., as described by scheme 1. On the other hand, compared with the CSI reports associated with set #0, the CSI reports associated with set #1 belong to different functionality, use a different model, or fall in different side of the boundary as in scheme 2 or 3, or indicated by the UE to use a different model, e.g., as described scheme 1. Moreover, the AI/ML resource is occupied based on when a report is configured, activated, triggered. However, this procedure can be applied even if the AI/ML resource is occupied based legacy CPU processing timeline. Set #0 includes P-CSI report #0 and AS-CIS report #1, while set #1 includes AP-CSI report #2.

There is no switching time required for releasing P-CSI report #0 and triggering AP CSI report #1. However, after the UE transmits AP CSI report #1, the UE may need some time to switch the AI/ML model before the gNB triggers AP CSI report #2, which belongs to different set than AP CSI report #1. The switching time may depend on the report type.

According to an embodiment, one of the following or any of combination thereof may be applied.
P-CSI report in set #0 to P-CSI report in set #1: the timeline may be measured from the release of the earlier P-CSI report to the configuration of latter P-CSI report.
P-CSI report in set #0 to SP-CSI report in set #1: the timeline may be measured from the release of the earlier P-CSI report to the when the activation command of the latter SP-CSI report to be applied.
P-CSI report in set #0 to AP-CSI report in set #1: the timeline may be measured from the release of the earlier P-CSI report to the when the triggering command of the latter AP-CSI report to be applied.
SP-CSI report in set #0 to P-CSI report in set #1: the timeline may be measured from when the deactivation command to be applied of the earlier SP-CSI report to the configuration of latter P-CSI report.
SP-CSI report in set #0 to SP-CSI report in set #1: the timeline may be measured from when the deactivation command to the when the activation command of the latter SP-CSI report to be applied.
SP-CSI report in set #0 to AP-CSI report in set #1: the timeline may be measured from when the deactivation command to the when the triggering command of the latter AP-CSI report to be applied.
AP-CSI report in set #0 to P-CSI report in set #1: the timeline may be measured from when the last symbol of the PUSCH carrying the CSI report to the configuration of latter P-CSI report.
AP-CSI report in set #0 to SP-CSI report in set #1: the timeline may be measured from when the last symbol of the PUSCH carrying the CSI report to the when the activation command of the latter SP-CSI report to be applied.
AP-CSI report in set #0 to AP-CSI report in set #1: the timeline may be measured from when the last symbol of the PUSCH carrying the CSI report to the when the triggering command of the latter AP-CSI report to be applied.
The triggering command of an AP CSI-report may be measured from the first symbol carrying PDCCH that trigger this AP CSI-report.

The UE may indicate, to the gNB, a minimum required time via capability signaling, or it may be predefined, e.g., provided in the specification. Moreover, the minimum required time may depend on the type of CSI reports.

The aforementioned mentioned approach can be further extended to reflect the time needed to switch between different AI/ML models or functionalities when a UE reaches its limit of the maximum number of simultaneous AI/ML models or functionalities that can run simultaneously. For example, the needed time to switch between functionalities or AI/ML model may be reflected as a timeline relaxation of the CSI report.

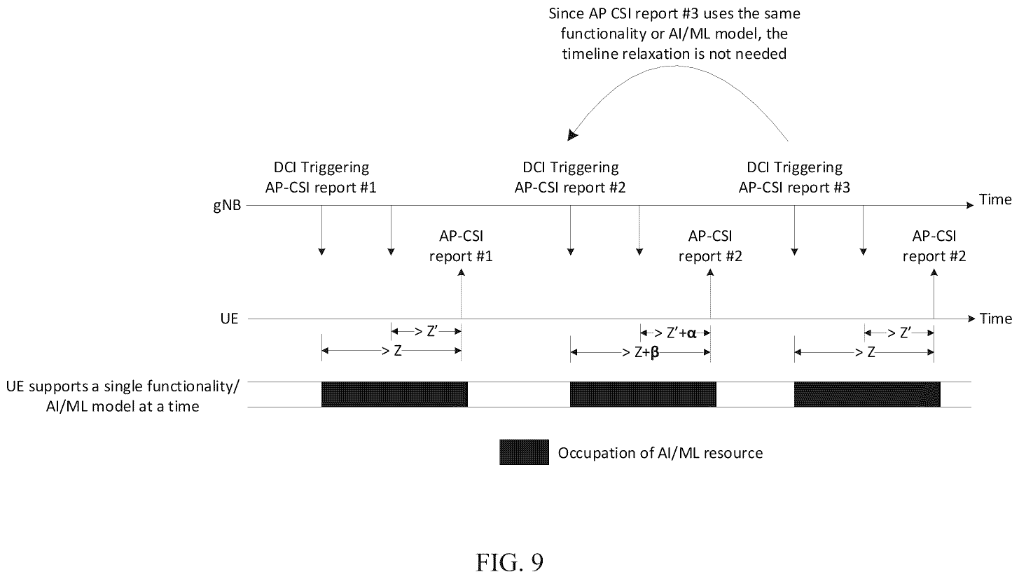

FIG. 9 illustrates an example of relaxation of a processing timeline due to functionality or AI/ML model switching, according to an embodiment.

Referring to FIG. 9, a UE is capable of running only a single functionality or AI/ML model, and three AP-CSI reports are associated with two functionalities or AI/ML models. More specifically, as shown in Table 4 below, an AP-CSI report #1 is associated with functionality or AI/ML model #1, while AP-CSI report #2 and #3 are associated with functionality or AI/ML model #2.

TABLE 4

| Functionality or AI/ML model | Associated CSI report |
|---|---|
| Functionality or AI/ML model #1 | AP CSI report #1 |
| Functionality or AI/ML model #2 | AP CSI report #2 |
| | AP CSI report #3 |

Assuming the functionality or AI/ML model #1 has been used earlier by the UE, no timeline relaxation is needed and legacy or new values of Z and Z′ can be used.

However, when a model switching is needed, the timeline relaxation is may be executed. Specifically, the AP-CSI report #2 using functionality or AI/ML model #2 differs from the one used by the previous report, and therefore, the timeline reflected by Z and Z′ may be relaxed by β and a, respectively.

Nevertheless, no timeline relaxation is needed for AP-CSI report #3 as it uses the same functionality or AI/ML as the one used by AP-CSR report #2.

The following illustrates possible timeline relaxation when a functionality or AI/ML model should be switched for different CSI report types and CSI-RSs.
AP-CSI reporting
   For AP-CSI reporting based on an AP CSI-RS, at least one of the following may be applied:
      Relax Z by β, i.e., Z+β, or
      Relax Z′ by α, i.e., Z′+α.
      If no functionality or AI/ML switching is needed, Z and Z′ are applied without relaxation.
      The value of α and β may be provided via UE capability signaling, or predefined. Additionally, the value may vary depending on the reporting quantity, the applied functionality or AI/ML model, the size of Set A, and the size of Set B.
   For AP-CSI reporting based on an SP CSI-RS or a P CSI-RS, at least one of the following may be applied:
      Relax at least Z by β, i.e., Z+β, or.
      If the downlink control information (DCI) to report CSI is in the same slot as the CSI request, the UE may not support this case, unless it indicates otherwise via UE capability. Additionally, the UE may indicate, to the gNB, via capability signaling, a needed number of symbols, e.g., t, between an SP/P CSI-RS and a first OFDM symbol of an AP-CSI reporting, or the value may be predefined.
      If the DCI to report CSI is not in the same slot as the CSI request, n_{CSI_ref} is z smallest value greater than or equal to └Z′+Y)/N_{symb}^{slot}┘, such that slot n-n_{CSI_ref} corresponds to a valid downlink slot, where Z′ corresponds to a delay requirement based on a report type.
      The value of β, τ, and γ may be provided via UE capability signaling, or predefined. Additionally, the value may vary depending on a reporting quantity, an applied functionality or AI/ML model, the size of Set A, and the size of Set B.
SP-CSI reporting
   For SP-CSI reporting based on an SP CSI-RS or a P CSI-RS at least one of the following may be applied:
      For SP reporting on a PUCCH, relax the 3 msec rule for a first SP-CSI report. Specifically, when the UE would transmit a PUCCH with HARQ-ACK information in slot n corresponding to a physical downlink shared channel (PDSCH) carrying an activation command, the indicated semi-persistent Reporting Setting should be applied starting from a first slot that is after slot (n+ϵ)+(3+η)Nₛₗₒₜ^{subframe,μ}, where μ is an SCS configuration for the PUCCH.
      For SP reporting on a PUSCH, legacy PUSCH preparation time, T_{proc,2} may be relaxed. For example, N₂ may be substituted with N₂+λ.
      Additionally, a location of a CSI reference resource may be modified for at least an initial SP-CSI report. Specifically, n_{CSI_ref} may be increased to provide more time for a functionality or model switching. For example, n_{CSI_ref}=(4+κ). 2^{μDL} may be used for when a single CSI-RS/SSB is configured; otherwise n_{CSI_ref}=(5+ρ). 2^{μDL}.
      The value of ϵ, η, λ, κ, and ρ may be provided via UE capability signaling, or predefined. Additionally, the value may vary depending on a reporting quantity, an applied functionality or AI/ML model, the size of Set A, and the size of Set B.
P-CSI reporting
   For P-CSI reporting based on a P CSI-RS, at least one of the following may be applied:
      The UE may indicate a minimum offset, e.g., ν, between a start of reporting period and a PUCCH carrying the report.
      Additionally, a location of a CSI reference resource may be modified for the initial P-CSI report. Specifically, n_{CSI_ref} may be increased to provide more time for a functionality or model switching. For example, n_{CSI_ref}=(4+κ). 2^{μDL} may be used when a single CSI-RS/SSB is configured; otherwise, n_{CSI_ref}=(5+p). 2^{μDL}.
      The value of ν, κ, and ρ may be provided via UE capability signaling, or predefined. Additionally, the value may vary depending on a reporting quantity, an applied functionality or AI/ML model, the size of Set A, and the size of Set B.

Table 5 below provides a high level summary of possible timeline relaxation in case a functionality or AI/ML switching is needed when a maximum number of running functionalities or AI/ML models is reached. If the functionality or the AI/ML model is already running, no timeline relaxation is needed.

TABLE 5

| | P CSI reporting | SP CSI reporting | AP CSI reporting |
|---|---|---|---|
| P | Define a minimum | For semi-persistent | Relax Z by β, or |
| CSI-RS | offset between the | reporting on PUCCH, | Relax n_{CSI}_{_{—}}_{ref} |
| | start of reporting | relax the MAC-CE | based on whether |
| | period and PUCCH | application time. | or not the DCI |
| | carrying the report. | For semi-persistent | carrying the CSI |
| | Relax n_{CSI}_{_{—}}_{ref} at | reporting on PUSCH, | request is in |
| | least for the initial | relax the PUSCH | the same slot |
| | P CSI report | preparation time. | of CSI report. |
| SP | Not supported | Relax n_{CSI}_{_{—}}_{ref} at | |
| CSI-RS | | least for the initial | |
| | | SP CSI report | |
| AP | Not supported | Not supported | Relax Z or Z′ |
| CSI-RS | | | |

As yet another possibility, the proposed relaxations may always be applied, regardless of whether there is a need to switch between different functionalities or AI/ML models. This may be beneficial to always relax the processing timeline.

Although in the previous examples each CSI report occupies a single AI/ML resource, in general, different CSI reports may occupy different numbers of AI/ML resources.

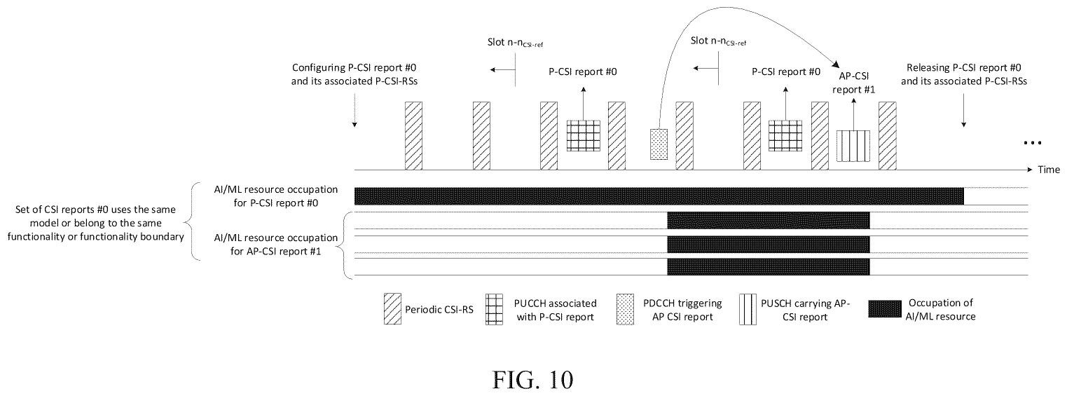

FIG. 10 illustrates an example of a CSI report occupying multiple AI/ML resources, according to an embodiment.

Referring to FIG. 10, P-CSI report #0 and AP CSI report #1 use the same AI/ML model, belong to the same functionality, fall within one side of the boundary in scheme 2 or 3, or are indicated by the UE, e.g., as described in scheme 1. The number of required AI/ML resources may be different for P-CSI report #0 and AP CSI report #1. This may be justifiable as processing some CSI reports may require additional processing capabilities than other CSI reports.

The number of AI/ML resources to be occupied by each CSI may depend on a report type, use case, report quantity, the size of Set A, the size of Set B, etc. For example, a CSI report associated with CSI prediction may occupy γ resources, a CSI report associated with spatial beam management may occupy δ resources, and a CSI report associated with temporal beam management may occupy ϵ resources.

Table 6 below provides an example of the number of occupied AI/ML resources depending on a report type.

TABLE 6

| Use case associated | | Number of occupied |
|---|---|---|
| with the CSI report | Report type | AI/ML resources |
| Spatial beam | Periodic CSI report | δ1 |
| management | Semi-persistent CSI report | δ2 |
| | Aperiodic CSI report | δ3 |
| CSI prediction | Periodic CSI report | γ1 |
| | Semi-persistent CSI report | γ2 |
| | Aperiodic CSI report | γ3 |
| . . . | . . . | . . . |

The UE may indicate, to the gNB, the values of γ, γ1, γ2, γ3, δ, δ1, δ2, δ3, etc., e.g., via capability signaling, which may reflect the complexity of each UE. Alternatively, such values may be predefined, e.g., provided in the specification.

In the aforementioned procedures, or any other procedures, to relax a CSI processing timeline and determine of a number of occupied AI/ML resources may depend on configuration details of each use case. For example, for a BM use case, the relaxation of a CSI processing timeline, e.g., increasing the value of Z or Z′, and/or shifting location of n_{CSI_ref}, may depend on a number of resources in Set A or Set B.

For a BM use case 2, relaxations may depend on a duration of a prediction/observation window. Similarly, a number of occupied AI/ML resources may depend on a number of resources in Set A or Set B. Also for the BM use case 2, a number of occupied AI/ML resources may depend on a prediction/observation window.

The UE may indicate, to the gNB, e.g., via capability signaling, relaxation values for a CSI processing timeline or for determining a number of occupied AI/ML resources. Alternatively, the values may be predefined, e.g., provided in the specifications.

Furthermore, some rules may be applied to determine such relaxation values. For example, Z′ for an AI/ML-based CSI report may be a scaled version of Z′ for a legacy CSI report, i.e., new Z′=α *legacy Z′. The scaling factor may be a function of a number of resources of Set B or Set A, or a duration of a prediction/observation window, e.g., α=the number of resources in Set B. Also, the UE may indicate, to the gNB, a value of α for a different combination of a number of resources of Set B or Set A, or a duration of the prediction/observation window. Similar rules may be applied for the determination of Z and CSI reference resource.

An AI/ML CSI report can occupy legacy CSI resources, i.e., legacy CPU, and AI/ML resources, i.e., CPU_{AI/ML}. For example, with CSI prediction, the preparation of the model input may include CSI-RS channel estimation, which is common for legacy CSI report and AI/ML-based CSI report. In this case, an AI/ML CSI report may also be considered to have occupied a legacy CPU as well as an AI/ML CPU.

Certain weight distributions are also possible. For example, an AI/ML CSI prediction report can be considered 1 legacy CPU and 1 AI/ML CPU, 0.5 legacy CPU or 0.5 AI/ML CPU, etc.

As described above, two pieces of information may be utilized to reflect the complexity of processing a CSI report deploying AI/ML mechanisms and may be indicated via capability signaling:
The number of different AI/ML models that may be used simultaneously, e.g., X_{active,i} or X_{active,total}.
For a particular model k, how many CSI reports may use this model simultaneously, e.g., X_{active within a model,k}.

The maximum number of simultaneous CSI reports using distinct AI/ML models and the maximum number of CSI reports using the same AI/ML model may determine a total number AI/ML resources available at the UE, which may be referred to as CPU_{AI/ML}. For example, CPU_{AI/ML} may be defined as shown in Equation (3):

$$C P {U}_{A I / M L} = {\sum }_{m = 1}^{{X}_{a c t ive , total}} {X}_{active within a model , m} , or \qquad ( 3 )$$

$$CP {U}_{A I / M L} = {\sum }_{i}^{Use cases} {\sum }_{m = 1}^{{X}_{a c t ive , i}} {X}_{active within a model , m}$$

Instead of indicating a maximum number simultaneous CSI reports using distinct AI/ML models and a maximum number of CSI reports using the same AI/ML model, the UE may indicate the following:
A number of different AI/ML models that may be used simultaneously, e.g., X_{active,i} or X_{active,total}, and
A total number of CPU_{AI/ML}.

In this case, the gNB may assume that the maximum number of simultaneous CSI reports using the same AI/ML model may depend on the indicated the number of different AI/ML models that may be used simultaneously and the total number of CPU_{AI/ML}, e.g., as shown in Equation (4).

$${X}_{active within a model , k} = \frac{C P {U}_{AI / ML}}{total number of AI / ML models} . \qquad ( 4 )$$

Another aspect is a relationship between a legacy N_{CPU} and a CPU_{AI/ML}.

According to an embodiment, any of the following alternatives or any of their combinations may be applied.
Separate the two parameters. In other words, the UE may be able to process an N_{CPU} legacy CSI report and CPU_{AI/ML} CSI reports deploying AI/ML.
The maximum number of legacy CSI reports may be affected by the number of CSI reports deploying AI/ML being processed. In other words, when no other CSI reports deploying AI/ML are being processed, the maximum number legacy CSI reports is N_{CPU}. However, when there are CSI reports deploying AI/ML being processed, the maximum number of legacy CSI report may be η N_{CPU}. The UE may indicate, to the gNB, the value of η, e.g., via UE capability signaling. Moreover, the value of η may be predefined, e.g., provided in the specifications. Additionally, the value of η may depend on the actual number of CSI report deploying AI/ML being processed. For example,

$$= \frac{C P {U}_{A I / M L} - {L}_{AI / ML}}{C P {U}_{A I / M L}} ,$$

where L_{AI/ML} is the number of occupied AI/ML resources.

Additionally, the UE may indicate, to the gNB, e.g., via capability signaling, whether the UE can simultaneously process legacy CSI reports and CSI reports deploying AI/ML mechanisms.

As the processing capability at the UE may change, e.g., due to limited power, it may be beneficial for the UE to turn off some AI/ML models/functionalities or reduce the number of simultaneous CSI reports that can be processed for particular model, or for all the models.

As described above in schemes 1, 2, and 3 or any other scheme, the UE may indicate, to the gNB, which CSI reports/functionalities use the same model. Therefore, the UE may indicate, to the gNB, which of these reports/functionalities may not use AI/ML model anymore. For example, a bitmap may be used for this pursue and its bitlength may be equal to the number of configured CSI reports deploying AI/ML mechanisms. A most significant bit may correspond to a lowest CSI report deploying AI/ML mechanism, a second most significant bit may correspond to a second lowest CSI report deploying AI/ML mechanism, etc. For example, if a bit is set to 1, the corresponding CSI report may not use AI/ML mechanism. Such bitmap may be carried in a MAC-CE or uplink control information (UCI). For such indicated CSI reports, any of the following options may be applied.
The CSI report may not be processed at all, or
The CSI report may be processed using legacy CSI processing techniques, not necessarily based on AI/ML mechanisms.

The UE may indicate, to the gNB, that all/some CSI reports associated with particular AI/ML model or all/some CSI reports that fall within one boundary, as described in the previous schemes or another scheme, cannot be processed. In this case, the UE may have additional capability to process a legacy CSI report. In other words, if the UE indicates some of its AI/ML processing capability is not available anymore, the UE's capability to process a legacy CSI report may be increased. Assuming that X AI/ML processing resources are indicated as unavailable, then the legacy CPU may be increased by λX, where the value of λ may indicated via UE capability signaling or may be predefined.

Rather than indicating whether each CSI report can still be processed by AI/ML mechanisms or not, the UE may indicate a modification to the indicated capability signaling.

Table 7 below shows an example of initial capability indications, e.g., via capability signaling, which may include the number the number of different AI/ML models that may be used simultaneously and the number simultaneous CSI reports that can be processed for each model. Thereafter, the UE may indicate, to the gNB, using a bitmap, which AI/ML model may be turned off. The bitlength may be equal to the number of indicated model. A most significant bit may correspond to a model with a lowest ID, a second most significant bit may correspond to a model with a second lowest ID, etc. If the bit correspond to model k is set to 1, this model may not be used. This may be equivalent to reducing CPU_{AI/ML} by X_{active within a model,k}. In this case, the UE's capability of processing legacy CSI report may be increased by X_{active within a model,k}, where the value of λ may indicated via UE capability signaling or predefined. This type of bitmap may be carried in UCI or a MAC-CE.

TABLE 7

| | | | Updating |
|---|---|---|---|
| Initial capability indication | | | bitmap |
| Number of different | # simultaneous CSI | Updating the | 0/1 |
| AI/ML models | reports for model #1 | indicated | |
| that may be used | # simultaneous CSI | capabilities → | 0/1 |
| simultaneously | reports for model #2 | | |
| (X_{active, total}.) | . . . | | . . . |
| | # simultaneous CSI | | 0/1 |
| | reports for model | | |
| | #X_{active, total} | | |

The UE may indicate, to the gNB, via capability signaling, whether the unused AI/ML capability, or the ones that are turned off after initially being indicated as available, may be transferred to increase the legacy CPU processing capability.

As yet another option to reflect the processing complexity of CSI report deploying AI/ML, legacy CPU framework may be used. For example, a number of occupied CPUs may depend on the use cases. For example, for a beam management use case, the number of occupied CPUs may be equal to one (similar to legacy). Alternatively, to reflect the complexity of an AI/ML model, a scaling factor, e.g., β, may be applied. The value of β may indicated via UE capability signaling or predefined, e.g., provided in the specification.

Moreover, the value of β may depend on the configurations of the use case. For example, in case of a beam management use case, the value of β may be a function of the sizes of set A and/or set B.

In terms of when a CPU is occupied, a legacy timeline may be followed. Alternatively, the UE may buffer the AI/ML and its corresponding parameters and keep memorizing. In order to reflect this complexity, the CPU may be occupied as follows:
For a P-CSI report, starting when the P CSI report is configured by higher layer signaling, and ending when the P CSI report is released.
For an SP-CSI report, starting from the end of when the activation command is applied, and ending at the end of when the deactivation command is applied.
For an AP-CSI report, starting from the end of the PDCCH containing the request and ending at the end of the scheduled PUSCH containing the report associated with this aperiodic CSI-RS.

The above-described operations, when separate AI/ML resources, e.g., CPU_{AI/ML}, are defined, may be applied when the complexity of a CSI report deploying AI/ML is reflected in a legacy CPU. For example, scaling the processing timelines (Z, Z′, CSI reference resource), number of occupied CPU may be performed based on the sizes of Set A and Set B. The relaxation in the timeline may also be utilized when a new AI/ML is loaded or deployed.

### Additional Condition

Additional conditions can be categorized into two categories: a UE side additional condition and a network (NW)-side additional condition. The UE is aware of a UE-side additional condition and can use that for data collection, condition-specific UE-side model training, and inference.

Similarly, a gNB can use the NW-side additional condition to collect data for condition-specific NW-side model training and inference, without any further signaling between the UE and the gNB.

In case of model training/inference at one node based on an additional condition on the other node, an indication of the additional condition can be done via signaling.
For a UE/UE side data collection for UE-side model training and inference, a gNB-side additional condition can be signaled to the UE. For example, a gNB beam codebook can be indicated as an ID, to the UE, for UE-side model training and inference.
For a NW/NW side data collection for NW-side model training and inference, a UE-side additional condition can be signaled to the NW. For example, the UE can signal an ID to indicate a Doppler level for NW-side CSI prediction. In a simple case, two IDs can be considered, where ID #1 indicates a low Doppler level and ID #2 indicates a high Doppler level.

Since different AI/ML models are expected to be developed for different additional condition IDs, with any of the above four “boundary condition” approaches, a UE may declare its support of certain additional condition IDs. For example, the UE may declare that it does not support additional condition ID #1 for the connected cell, or it may declare that it does not support certain additional condition IDs with certain functionalities conditions. In terms of drawing boundary conditions, it can include the additional condition ID within boundary conditions. For example, the UE can draw the condition as shown Table 8 below.

TABLE 8

| | |
|---|---|
| Boundary | Set A, B such that the size of set A and B is within |
| condition #1 | range #1: \|B\| ≤ Y₁, \|A\| ≤ Z₁ with additional |
| | condition ID #1 |
| Boundary | Set A, B such that the size of set A and B is within |
| condition #2 | range #1: \|B\| ≤ Y₁, \|A\| ≤ Z₁ with additional |
| | condition ID #2 |
| Boundary | Set A, B such that the size of set A and B is within |
| condition #3 | range #1: Y₁ < \|B\| ≤ Y₂, Z₁ < \|A\| ≤ Z₂ with |
| | additional condition #1 |
| Boundary | Set A, B such that the size of set A and B is within |
| condition #4 | range #1: Y₁ < \|B\| ≤ Y₂, Z₁ < \|A\| ≤ Z₂ with |
| | additional condition #2 |
| Boundary | Set A, B such that the size of set A and B is within |
| condition #5 | range #1: Y₂ < \|B\| ≤ Y₃, Z₂ < \|A\| ≤ Z₃ with |
| | additional condition #1 |
| Boundary | Set A, B such that the size of set A and B is within |
| condition #6 | range #1: Y₂ < \|B\| ≤ Y₃, Z₂ < \|A\| ≤ Z₃ with |
| | additional condition #2 |

### Relationship Between Functionality and CSI Report

AI/ML functionality may be fully integrated in a CSI report, i.e., the additional configurations or information to deploy the AI/ML functionality are provided as part of the CSI report configuration/activation/triggering as shown in scheme 4, for example. Therefore, when the CSI report is configured/activated/triggered, the UE may use such additional confirmations or information to generate the CSI report.

As another option, the additional configurations or information to deploy the AI/ML functionality may be separately provided, outside of the CSI report. The gNB may provide the UE with the linkage between the AI/ML functionality and the CSI report.

Table 9 below shows an example of a list of configured functionalities, e.g., provided via higher layer signaling such as RRC. Each configured functionality may include any of the following:
“Functionality Index” that indicates the functionality index.
“Functionality type” that may include a type of AI/ML functionality such as spatial beam management, temporal beam management, CSI prediction, etc.
Additional information depending on the use case or functionality type.
   For spatial beam management, the configurations may provide a list of RSs included in Set A by indicating, e.g., csi-ResourceConfigId, nzp-CSI-ResourceSetId, etc. Additionally, the configurations may include a list of RSs included in Set B by indicating, e.g., csi-ResourceConfigId, nzp-CSI-ResourceSetId, etc.
   For temporal BM, in addition to the configurations for spatial BM, the configurations may include information on the prediction window and observation window. For example, periodicity, offset, and duration in each window may be provided.
   For CSI prediction, the configurations may include information on the applicable subband for example.
A special index may be reserved to indicate that no AI/ML functionality is to be applied, e.g., functionality index #0 or N. Alternatively, for a particular functionality index, the gNB may indicate the functionality type as “No AI/ML”. This may be beneficial for the gNB to turn off the AI/ML model associated with a particular CSI report. In such case, the UE may apply a legacy CSI report, not based on AI/ML.

TABLE 9

| Functionality | |
|---|---|
| Index | Functionality configurations |
| 0 | Functionality type: Spatial beam management |
| | Set A: csi-ResourceConfigId |
| | Set B: csi-ResourceConfigId |
| 1 | Functionality type: Temporal beam management |
| | Set A: csi-ResourceConfigId |
| | Prediction window: periodicity, offset and duration |
| | Set B: csi-ResourceConfigId |
| | Observation window: periodicity, offset and duration |
| . . . | |
| N − 1 | Functionality type: CSI prediction |
| | # of subbands |
| N | Functionality type: No AI/ML (legacy reporting) |

To link a functionality with a CSI report, a gNB may provide a UE with a functionality index as part of CSI report configurations. Therefore, when a CSI report is configured, the UE is aware of an AI/ML functionality to be associated with the CSI report.

Since the AI/ML functionality may include RSs for channel measurement and/or interference measurement, the configurations of a legacy CSI report may not include resourcesForChannelMeasurement, which is currently a mandatory field in the CSI-reportConfig.

To provide the gNB with more flexibility, CSI-reportConfig may be linked with multiple candidate functionalities. In this case, the gNB may indicate, to the UE, which functionality may be used. This may be beneficial as the gNB may able to dynamically choose/update the functionality associated with CSI-reportConfig depending on the performance, power consumption, etc.

The gNB may provide the UE with a list of the candidate functionalities associated with a particular CSI report. For example, as part of a CSI-reportConfig, the gNB may provide the UE with a list of candidate functionality indices, e.g., an RRC parameter functionality_list. In this case, the gNB may indicate the functionality associated a CSI report via a MAC-CE or DCI.

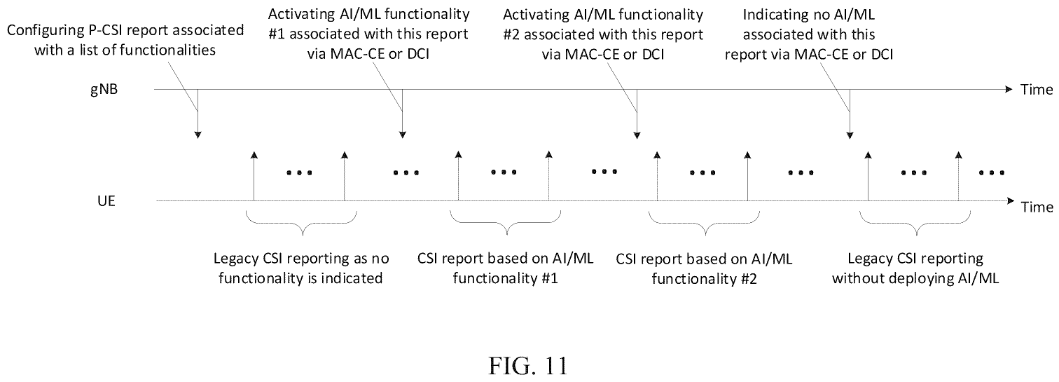

FIG. 11 illustrates an example of indicating AI/ML functionality associated with a P-CSI report, according to an embodiment. More specifically, FIG. 11 illustrates an example of P-CSI reporting associated with a list of candidate AI/ML functionalities.

Referring to FIG. 11, after a P-CSI is configured and before receiving an indication of which AI/ML functionality to be applied, the UE may generate the CSI report based on legacy approaches.

As an alternative, a particular AI/ML functionality may be applied until receiving an indication of which AI/ML functionality to be applied. For example, the AI/ML functionality with a smallest/highest index may be applied until receiving an indication of which AI/ML functionality to be applied. Furthermore, the gNB may configure a flag indicating which AI/ML functionality may be applied until receiving an indication of which AI/ML functionality to be applied.

FIG. 11 also shows that the gNB transmits, to the UE, either a MAC-CE or DCI carried by a PDCCH, e.g., to indicate which functionality is to be applied for the CSI report, i.e., AI/ML functionality #1 and then followed by AI/ML functionality #2. Thereafter, the gNB indicates, to the UE, via a MAC-CE or DCI carried by the PDCCH, to turn off the AI/ML. Specifically, the gNB indicates a functionality index associated with “no AI/ML”

For an SP-CSI report on a PUCCH, the MAC-CE triggering this report may also indicate the AI/ML functionality associated with the activated SP-CSI report on the PUCCH. Specifically, a new field may be provided in the MAC-CE, or an existing field that is repurposed, may be used to indicate an AI/ML functionality out of the list associated with SP-CSI report on the PUCCH.

Table 10 below shows an example of a MAC-CE activating an SP-CSI report on a PUCCH by setting a bit corresponding to the report to be 1. Additionally, the activation MAC-CE indicates an AI/ML functionality out of the list of AI/ML functionalities associated with the SP-CSI report.

Similar to a P-CSI report, separate MAC-CEs or DCI, different from the MAC-CE that activated the SP-CSI report, may be used to update the functionality associated with the already activate SP-CSI report.

TABLE 10

| MAC-CE bits | | AI/ML functionality |
|---|---|---|
| activating | | index indicated |
| SP CSI report | | via the |
| on PUCCH | SP CSI report Index | activation MAC-CE |
| 0 | CSI-ReportConfigId = 2 | No AI/ML |
| | With AI/ML functionality_List = | |
| | {1, 2, No AI/ML} | |
| 1 | CSI-ReportConfigId = 3 | 3 |
| | With AI/ML functionality_List = | |
| | {3, No AI/ML} | |
| 2 | CSI-ReportConfigId = 4 | 1 |
| | With AI/ML functionality_List = | |
| | {1, No AI/ML} | |
| 3 | CSI-ReportConfigId = 5 | 2 |
| | With AI/ML functionality_List = | |
| | {1, 2, 3, No AI/ML} | |

Similarly, for an SP-CSI report on a PUSCH or an AP-CSI report, the activating/triggering DCI may indicate the associated AI/ML functionality by introducing new fields or repurposing some of the existing field for each activated/triggered report. Alternatively, to reduce the signaling overhead, for each triggering state for SP-CSI reports on a PUSCH or AP CSI reports, the gNB may configure a list of AI/ML functionalities associated with all CSI reports linked to this state. In this case, the gNB may indicate the AI/ML functionality per state, rather than for each CSI report in the triggered state. In other words, the same indicated AI/ML functionality is applied to CSI report linked to the triggered state.

After triggering the SP-CSI report on a PUSCH, separate a MAC-CE or DCI, different from the DCI that triggered the SP-CSI report on the PUSCH, may be used to update the functionality associated with the already triggered SP-CSI report on the PUSCH.

When the AI/ML functionality is separately indicated from the signal triggering or activating CSI report, the UE may need some time to receive, decode, and apply the AI/ML functionality indication. For example, when a MAC-CE is used to indicate the AI/ML functionality, the indication may be applied for the CSI reports in slot k+3Nₛₗₒₜ^{subframe,μ}, where k is the slot in which the UE would transmit a PUCCH or a PUSCH with hybrid automatic repeat request (HARQ)-acknowledgement (ACK) information for a PDSCH providing the MAC CE and μ is the SCS configuration for the PUCCH or PUSCH, respectively.

Alternatively, RS(s) associated with the report may be transmitted in slot k+3. Nₛₗₒₜ^{subframe,μ} slot, where k is the slot in which the UE would transmit a PUCCH or a PUSCH with HARQ-ACK information for the PDSCH providing the MAC CE and μ is the SCS configuration for the PUCCH or PUSCH, respectively.

Similarly, when DCI is used for indicating AI/ML functionality, a particular time gap between the PDCCH carrying the indication and CSI report or the RSs that are associated with that report may be needed before the new indicated AI/ML functionality is applied. This time gap may be in units of orthogonal frequency division multiplexing (OFDM) symbols, slots, etc. It may be predefined, e.g., provided in the specification, or indicated by the UE, to the gNB, via capability signaling.

Before the applicability of the AI/ML functionality indicated by the MAC-CE or DCI, the previous AI/ML functionality or no AI/ML may be applied.

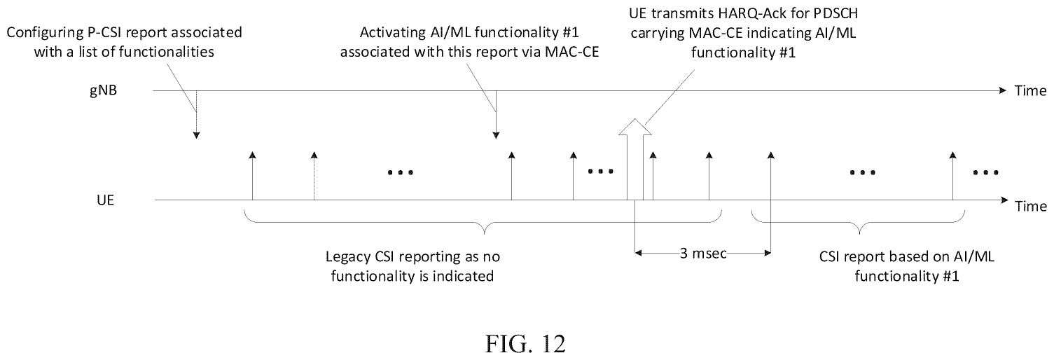

FIG. 12 illustrates a timeline for applying an AI/ML functionality indicated via a MAC-CE, according to an embodiment. More specifically, FIG. 12 illustrates an example of using a MAC-CE for indicating the AI/ML functionality associated with a P-CSI report.

Referring to FIG. 12, a UE applies legacy CSI reporting until an indication of AI/ML functionality is received. The UE maintains the legacy CSI reporting until 3 msec after transmitting a HARQ-ACK for a PDSCH carrying MAC-CE indicating a new AI/ML functionality. This is equivalent to applying the AI/ML functionality the CSI report to be transmitted in slot k+3. Nₛₗₒₜ^{subframe,μ}, where k is the slot in which the UE would transmit a PUCCH or PUSCH with HARQ-ACK information for the PDSCH providing the MAC CE and μ is the SCS configuration for the PUCCH or PUSCH, respectively.

When AI/ML functionality is activated by a separate MAC-CE or DCI, i.e., not the ones used for activating the SP/AP-CSI report, or does not have a triggering/activation signaling, i.e., P-CSI report, the gNB may inform the UE about the associated CSI report. For example, the MAC-CE or DCI may carry an index of an AI/ML functionality to be activated and an associated CSI report. The MAC-CE or DCI may carry the indices of multiple AI/ML functionalities and the associated CSI report ID.

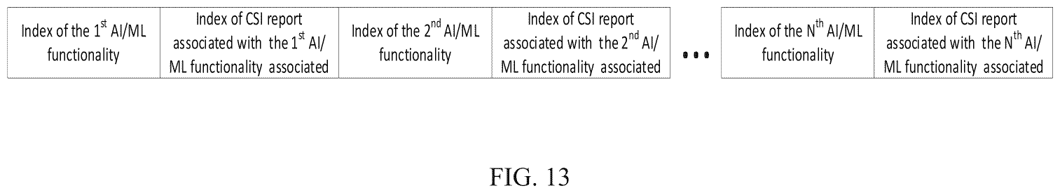

FIG. 13 illustrates an example of fields of DCI or a MAC-CE indicating an AI/ML functionality and a corresponding CSI report, according to an embodiment.

Referring to FIG. 13, there are N pairs of fields indicated to a UE to reduce signaling overhead. The number of N may configured by higher layer signaling. To keep the size the fields fixed, a bitwidth of a field indicating an index of AI/ML functionality may be equal to log 2 (max(AI/ML functionality_List for all configured CSI reports)).

### Model-ID-Based LCM

### UE Capability on the Number of Models/Functionalities

In model-ID-based LCM, models are identified/registered to the NW. As it is not an efficient use of resources for a UE to identify two different models, which are logical and correspond to the same physical model, it is assumed herein that each logical model identified to a gNB has a distinct physical model. However, it is possible that one logical model corresponds to multiple different physical models, e.g., the UE may have a low-complexity and high complexity model or a given AI/ML feature/functionality.

Once models are identified, the UE may report, to the gNB, which models it supports. Due to the nature of model identification and capability reporting, a concern over the number of supported models as in the functionality-based LCM, should not be an issue in model-ID-based LCM. However, one aspect to be considered is the possibility of having multiple physical models for one logical identified model. This itself can be handled in a UE capability report as the UE is aware of such a condition and may adjust its capability report according to this condition.

### UE Capability Report Details:

A UE may report, to a gNB, which models among the identified models the UE supports. The signaling can be as follows.
The first part of the signaling includes a UE vendor ID.
The second part includes indices of the supported models identified by the UE vendor. If a UE vendor identifies N models to the gNB, this part can be a bitmap of length N, where each of the N elements corresponds to an identified model in an ascending or descending order of the model ID. Basically, from a gNB/UE point of view, once the vendor is identified, the identified models may be assigned local logical IDs from 0 to N−1. Thereafter, the UE may declare support via the bit-map.

In addition to indicating, to the gNB, the supported model IDs, the UE may also declare as a capability report, a maximum number, e.g., N_{active,max}, of simultaneous activated models. The UE does not expect that the gNB will activate more than N_{active,max} models simultaneously.

To take into account the additional complexity due to running multiple physical models for the same identified logical model, the UE may also report a scalar value αᵢ>1, for each supported model ID i (e.g., a can also be identified to the NW during model identification). The UE does not expect that the gNB will activate more than N_{active,max} models simultaneously, where the number of activated models is calculated considering the scaling value αᵢ. In other words, if the gNB activates models with IDs in set S⊂{0, . . . , N−1}, the number of activated models is calculated as shown in Equation (5):

$$Number of activated models = {\sum }_{i ∈ S} {α}_{i} , \qquad ( 5 )$$

which UE expects to be not greater than N_{aactive,max}.
Meta Information and Co-Existence with Legacy RRC Configurations

This section deals with a type of information, referred to as meta information, which is revealed to the NW when a model is identified. There are different possibilities for what meta information may include.

In accordance with an embodiment, meta information includes all necessary information for the model inference. In this case, a gNB activating a certain model, is equivalent to performing all RRC configurations required for inference. For example, with CSI compression, meta information includes all of the information that would have been provided in the RRC configuration via CSI report configuration. That is, when the gNB activates a model ID, it activates a specific CSI report configuration. In legacy NR, a CSI report configuration includes information on a sub-band configuration, codebook type, etc. All of this information may also be included in the meta information. In particular, a codebook type may be replaced by a model ID, which in this case points to a specific decoder that is equivalent to the legacy codebook, with the encoder being a legacy PMI search algorithm. Similar to CSI compression, all of the one-sided models can also work in this way. This method saves RRC overhead, but may affect a gNB's flexibility, as 1) each functionality/RRC configuration should be done via model identification, and 2) unlike legacy NR, it may not be the gNB that configures the meta information.

In accordance with another embodiment, meta information co-exists with a legacy RRC configuration. Taking the CSI compression as an example, a gNB can configure a CSI report configuration with a modification. That is, instead of specifying a codebook type, the CSI report configuration indicates a model ID (decoder ID, pair ID). With CSI prediction, the gNB can still configure a CSI report with prediction parameters, e.g., a monitoring/prediction window. That is, with CSI prediction functionality, a UE may measures a downlink channel (e.g., measuring the CSI-RSs) in a window of slots referred to as a conservation window, and predict a CSI in a window of slots referred to as a prediction window. The time domain behavior of observation and prediction window should be provided in a CSI report configuration via RRC. The gNB can still indicate, to the UE, a model ID to match the current additional condition.

### Model Identification

For model-ID-based LCM, different model identification types (i.e., Type A, Type B1, Type B2) have been identified for study and corresponding outputs are captured in Section 4.2.2 of TR 38.843 as follows in Table 11.

TABLE 11

| | For UE-side models and UE-part of two-sided models: | |
|---|---|---|
| - | For AI/ML functionality identification | |
| | - | Legacy 3GPP framework of feature is taken as a starting point. |
| | - | UE indicates supported functionalities/functionality for a given sub-use-case. |

| | |
|---|---|
| - | UE capability reporting is taken as starting point. |

| - | For AI/ML model identification | |
|---|---|---|
| | - | Models are identified by model ID at the Network. UE indicates supported AI/ML |
| | | models. |

| | |
|---|---|
| | ... |
| 4.2.2 | Model identification |

For AI/ML model identification of UE-side or UE-part of two-sided models, model
identification is categorized in the following types:

| - | Type A: Model is identified to NW (if applicable) and UE (if applicable) without over- | |
|---|---|---|
| | the-air signaling | |
| | - | The model may be assigned with a model ID during the model identification, which |
| | | may be referred/used in over-the-air signaling after model identification. |
| - | Type B: Model is identified via over-the-air signaling, | |
| | - | Type B1: |

| | |
|---|---|
| - | Model identification initiated by the UE, and NW assists the remaining steps (if |
| | any) of the model identification |

| | |
|---|---|
| - | the model may be assigned with a model ID during the model identification |

| - Type B2: | |
|---|---|
| - | Model identification initiated by the NW, and UE responds (if applicable) for the |
| | remaining steps (if any) of the model identification |

| | |
|---|---|
| - | the model may be assigned with a model ID during the model identification |

| | | |
|---|---|---|
| - | Note: | This study does not imply that model identification is necessary. |

One example use case for Type B1 and B2 is model identification in model transfer from
NW to UE. Another example is model identification with data collection related
configuration(s) and/or indication(s) and/or dataset transfer. Note: Other example use cases
are not precluded. Note: Offline model identification may be applicable for some of the
example use cases.
Once models are identified, at least for Type A, UE can indicate supported AI/ML model IDs
for a given AI/ML-enabled Feature/FG in a UE capability report as starting point. Note:
model identification using capability report is not precluded for type B1 and type B2.
Model ID may or may not be globally unique, and different types of model IDs may be
created for a single model for various LCM purposes. Note: Details can be studied in the WI
phase.

RAN1 further reached the following agreement on identification type A, as shown in Table 12.

TABLE 12
Agreement

| • | To facilitate the discussion, RAN1 studies the model identification type A with more details | |
|---|---|---|
| | related to use cases. | |
| • | To facilitate the discussion, RAN1 studies the following options as starting point for model | |
| | identification type B with more details related to all use cases | |
| | • | MI-Option 1: Model identification with data collection related configuration(s) and/or |
| | | indication(s) |
| | • | MI-Option 2: Model identification with dataset transfer |
| | • | MI-Option 3: Model identification in model transfer from NW to UE |
| | • | FFS: The boundary of the options |
| | • | Note: the names (MI-Opton1, MI-Option 2, MI-Option 3) are used only for discussion |
| | | purpose |
| | • | Note: other options are not precluded |

Observation
The other options are proposed for model identification type B by companies during the
discussion:

| | |
|---|---|
| • | MI-Option 4. Model identification via standardization of reference models. (for CSI |
| | compression) |

MI-Option 5. Model identification via model monitoring
Agreement
From RAN1 perspective, for UE-sided model(s) developed (e.g., trained, updated) at UE side,
following procedure is an example (noted as AI-Example1) of MI-Option1 for further study
(including the feasibility/necessity)

| | |
|---|---|
| • | A: For data collection, NW signals the data collection related configuration(s) and it/their |
| | associated ID(s) |

| | |
|---|---|
| ∘ | Associated IDs for each sub use case in relation with NW-sided additional conditions |

| | |
|---|---|
| [symbol] | B: UE(s) collects the data corresponding to the associated ID(s) |
| [symbol] | C: AI/ML models are developed (e.g., trained, updated) at UE side based on the collected |
| | data corresponding to the associated ID(s). |
| • | D: UE reports information of its AI/ML models corresponding to associated IDs to the NW. |
| | Model ID is determined/assigned for each AI/ML model |

| | |
|---|---|
| ∘ | relationship between model ID(s) and the associated ID(s) |
| ∘ | How model ID(s) is determined/assigned, e.g., |

| | |
|---|---|
| ▪ | Alt.1: NW assigns Model ID |
| ▪ | Alt.2: UE assigns/reports Model ID |
| ▪ | Alt.3: Associated ID(s) is assumed as model ID(s) |

| | |
|---|---|
| • | “Model ID is determined/assigned for each AI/ML model” in D is not |
| | needed |

| | |
|---|---|
| ▪ | Alt.4: Model ID is determined by pre-defined rule(s) in the specification |

| | |
|---|---|
| ∘ | FFS: how to report |
| ∘ | Note: D is to facilitate AI/ML model inference |

| | |
|---|---|
| • | Note: Step A/B/C and additional interaction of associated IDs between UE and NW can be |
| | considered as a different solution for resolving the consistency without model identification. |

With MI-option 1 in Table 12, the NW may indicate a data collection ID during data collection and then later during inference. The ID can be used to ensure consistency between training and inference.

With MI-option 2, the NW may transfer a data set with an ID to the UE. The UE trains a model with the data set. The logical model ID is the data set ID.

With MI-option 3, the NW trains and transfer a model to the UE.

With MI-option 4, reference model(s) are each assigned an ID. The UE may develop encoders for each reference decoder model. The model or pairing ID may that of the decoder reference model ID.

Model identification can also be carried out via performance monitoring. The UE may develop multiple models by classifying the data set during data collection into different classes. Later, during an inference phase, the UE may check the performance of each model and report, to the gNB, that it is using a specific model for the current NW side additional condition. The gNB may further assign a model ID to the model that the UE is currently using for inference.

For ease of description, in the following, an embodiment is described with reference to a UE-side model. During a phase of data collection for training, the NW signals a dataset/associated ID, which indicates a specific gNB implementation, e.g., a beam codebook, without revealing any more information. That is, the implementation is abstracted into an ID. The training entity, e.g., the UE, may develop multiple models, i.e., one model for each ID. When the UE connects to the gNB, it can report to the gNB that it has developed models for data set IDs ID₁, . . . , ID_{M}. These models can then be identified to the NW, each with an assigned model ID.

A model ID may be determines as follows:
A: The model IDs are equal to the data set IDs.
B: Model IDs are indexed from 0 to M-1 in ascending order of the data set IDs. That is, the model corresponding to the lowest data set ID is assigned a value of 0, the model corresponding to the second lowest data set ID is assigned a value of 1, etc.
Model IDs are assigned via a predefined function as set forth in the specification. In the simplest form, there is one-to-one mapping between the model IDs and the data set IDs. On the other hand, the UE may develop a single model for multiple NW side IDs. In the latter case, multiple data set IDs can be mapped to the same model ID. The UE indicates, to the gNB, which set of data set IDs are mapped to one model ID.

The UE may also assign model IDs to each data set ID and report them to the gNB. The reported model IDs may be considered as final model IDs from a gNB point of view, or the gNB may further assign the model IDs after UE's report.

After models are identified, in the inference phase, the gNB may simply indicate a model ID with a functionality configuration. For example, in a CSI report configuration, the gNB may indicate the model ID, e.g., for the UE to apply a model that matches a NW side additional condition.
Global or Local data set ID

To capture all different NW side additional conditions, or data set IDs, the specification may define a global set of IDs used across sites, locations, countries, etc. These IDs are universal and may include the NW vendor ID. For example, each NW vendor may be assigned a vendor ID. Each vendor additionally may have some vendor specific IDs capturing different implementations. A site/location/country/continent ID may also be used to capture other factors on top of an NW ID and an NW-specific implementation ID, which can affect the UE's environment or data collection. These IDs together may form a global NW side additional condition or data set ID.

Alternatively, the data set IDs may be localized. That is, a set of cell-specific/site specific IDs may be used to capture different NW side additional condition. These IDs can then be signaled in system information to the UE. For example, this alternative, may work well for a UE that only/mainly operates in the same site/cell.

Model-ID-based LCM may also co-exist with functionality-based LCM. That is, an NW performs the LCM on the functionality level by activating/deactivating functionalities via signaling, along with indication of a model UE is expected to be used for the functionality. For example, this can be done by assigning a model ID based on the additional condition/associated ID as described above.

UE capability report for applicable functionalities

In the above sections, functionality and model-ID-based LCM have been described. Assuming model-ID-based LCM co-exist within functionality-based LCM, e.g., by NW indicating the models to use within an active functionality. Once functionalities are configured, and prior to activation, the applicability of such functionalities may be again indicated by UE to the gNB. Recall that we have the following types of functionalities.
Identified functionalities: functionalities corresponding to conditions indicated by UE capability (i.e., all possible configurations that may be supported based on conditions indicated by UE capability)
Configured functionalities: functionalities that are configured by the NW among identified functionalities
Applicable functionalities: functionalities that are currently applicable at the UE among identified functionalities
Activated functionality: the functionality that is currently activated from the set of applicable functionalities

Activation/deactivation of functionalities are performed on “applicable functionalities”. Applicable functionalities may be different from configured functionalities. For example, depending on a UE internal condition, a UE may not support certain configured/identified functionalities. As another example, if a UE hands over to a new cell, the UE may not support the functionality for the new cell, e.g., due to a change in the associated ID. For these types of reasons, after functionalities are configured to the UE based on the identified functionalities (i.e., properties of supported functionalities supported by the UE), the UE should be able to declare its capability on which configured/identified functionalities are applicable.

According to an embodiment, the following indications are possible:
Indication type 1 (Applicable functionality among the configured ones): A UE may indicate, via bitmap, which one of the configured functionalities are applicable now. For example, with N configured functionalities, the indication can be a length-N binary bit map with a I/O in the index number i implying that the functionality number i is or is not supported. A potential problem with this approach, however, is that the UE can only indicate updated support of currently configured functionalities, which may be a limited flexibility since the UE may also be able to support a functionality that is not currently configured.
Indication type 2 (Applicable functionalities among the identified ones): Recall that in functionality-based LCM, a UE may indicate, to the gNB, properties of a supported/valid functionality, which may be referred to as identified functionalities with a slight inaccuracy. In this approach, after functionality configurations, the UE may indicate applicable functionalities by updating properties of supported functionalities/identified functionalities, e.g., by a new indication of the properties of set A and set B.

### Associated ID/Additional Condition ID/Model ID:

functionality configuration includes associated ID: In this case,
   with indication type 1, as part of indicating the applicable functionalities, it also indicates which associated IDs it supports for the functionality. For example, the UE declares that functionality #1 is applicable, which indicates a certain associated ID is applicable.
   With indication type 2, a UE may report the properties of the functionalities including the association with the associated IDs. For example, the UE can indicate that it can support certain properties of set A and set B with certain associated IDs as explained in the “Additional condition” section.
functionality configuration does not include associated ID: In this case, an associated ID is indirectly included via the associated RS for channel measurement for the functionality.
   With indication type 1, in addition to indicating the applicable functionalities, the UE also indicates which associated IDs the UE supports for DL transmission of the reference signals for measurement of each functionality.
   With indication type 2, in addition to the properties of the identified functionalities within each boundary, the UE may also report which associated IDs it supports for the DL transmission of the RS for channel measurements for the functionalities within each boundary.

### Cell-Specific Associated ID

The description above mainly assumes that associated IDs are global, which means that certain additional IDs indicate the same gNB transmission implementation, e.g., a gNB beam codebook, across the cells. Accordingly, a UE capability framework in NR does not need any modification beyond introducing the associated ID features/components.

However, if the associated IDs are local, it means that an ID of 0 in a first cell does not imply the same gNB implementation as it does in a second cell. In this case, a cell-specific UE capability reporting should be used. In particular, after a UE connects to ah NW, a gNB may provide the UE with a set of associated IDs for the cell, and the UE may declare its capability of which IDs it supports. The UE may acquire the NR global cell ID (NGCI) and based on its training sessions, it will know which IDs it supports for the connected cell. The UE may transmit the supported associated IDs in a UL channel as a UCI, e.g., as L1 signaling, or as part of a capability signaling IE within current NR framework, e.g., higher layer signaling.

The above mechanism for cell-specific associated ID UE capability report, can also be used with any of the boundary condition frameworks as described above.

### Performance Monitoring

Monitoring the performance of AI/ML models and reporting the performance to a gNB can be used to improve system performance. A UE or gNB may monitor the performance of a model and make proper LCM decisions in case the performance is not satisfactory. For example, if a gNB is performance monitoring, it may signal to activate a model, switch a model, or fall back to a legacy operation.

Table 13 provides some the agreements reached in the general framework agenda item.

TABLE 13
TR 38.843:
Performance monitoring
The following metrics/methods for AI/ML model monitoring in lifecycle management per use
case are considered:

| - | Monitoring based on inference accuracy, including metrics related to intermediate key | |
|---|---|---|
| | performance indicators (KPIs) | |
| - | Monitoring based on system performance, including metrics related to system | |
| | performance KPIs | |
| - | Other monitoring solutions, at least the following 2 options. | |
| | - | Monitoring based on data distribution |

| | |
|---|---|
| - | Input-based: e.g., Monitoring the validity of the AI/ML input, e.g., out-of- |
| | distribution detection, drift detection of input data, or SNR, delay spread, etc. |
| - | Output-based: e.g., drift detection of output data |

| | |
|---|---|
| - | Monitoring based on applicable condition |

| | |
|---|---|
| Note: | Monitoring metric calculation may be done at NW or UE |

Methods to assess/monitor the applicability and expected performance of an inactive
model/functionality, including the following examples for the purpose of
activation/selection/switching of UE-side models/UE-part of two-sided models /functionalities
(if applicable):

| | |
|---|---|
| - | Assessment/Monitoring based on the additional conditions associated with the |
| | model/functionality |
| - | Assessment/Monitoring based on input/output data distribution |
| - | Assessment/Monitoring using the inactive model/functionality for monitoring purpose |
| | and measuring the inference accuracy |
| - | Assessment/Monitoring based on past knowledge of the performance of the same |

model/functionality (e.g., based on other UEs)

Table 14 provides three types of monitoring RAN1 has considered for different use cases. More specifically, Table 14 shows the monitoring types for CSI prediction use case.

TABLE 14
Agreement
For CSI prediction using UE side model use case, at least the following aspects have been
proposed by companies on performance monitoring for functionality-based LCM:

| • | Type 1: | |
|---|---|---|
| | ∘ | UE calculate the performance metric(s) |
| | ∘ | UE reports performance monitoring output that facilitates functionality fallback |
| | | decision at the network |

| | |
|---|---|
| ▪ | Performance monitoring output details can be further defined |
| ▪ | NW may configure threshold criterion to facilitate UE side performance |
| | monitoring (if needed). |

| | ∘ | NW makes decision(s) of functionality fallback operation (fallback mechanism |
|---|---|---|
| | | to legacy CSI reporting). |
| • | Type 2: | |
| | ∘ | UE reports predicted CSI and/or the corresponding ground truth |
| | ∘ | NW calculates the performance metrics. |
| | ∘ | NW makes decision(s) of functionality fallback operation (fallback mechanism |
| | | to legacy CSI reporting). |
| • | Type 3: | |
| | ∘ | UE calculate the performance metric(s) |
| | ∘ | UE report performance metric(s) to the NW |
| | ∘ | NW makes decision(s) of functionality fallback operation (fallback mechanism |
| | | to legacy CSI reporting). |
| • | Functionality selection/activation/ deactivation/switching what is defined for other UE | |
| | side use cases can be reused, if applicable. | |
| • | Configuration and procedure for performance monitoring | |
| | ∘ | CSI-RS configuration for performance monitoring |

| | |
|---|---|
| [symbol] | Performance metric including at least intermediate KPI (e.g., normalized mean square |
| | error (NMSE) or squared generalized cosine similarity (SGCS)) |
| • | UE report, including periodic/semi-persistent/aperiodic reporting, and event driven |
| | report. |
| • | Note: down selection is not precluded. |
| • | Note: UE may make decision within the same functionality on model selection, |
| | activation, deactivation, switching operation transparent to the NW. |

Although the agreement is written for the case of CSI prediction, it may be applicable to other use case. For example, with a BM use case and Type-2 monitoring, with an NW-side model, a UE can report the measured ground-truth (GT) reference signal received powers (RSRPs) to the gNB, and the gNB can calculate a performance metric and make LCM decisions for its own model.

Herein below, methods are provided for performance monitoring at a UE and/or gNB side.

### Monitoring Inactive Models

According to an embodiment, a UE has certain models activated and being used for inference. It also has a number of inactive models, which are candidate models for performing the inference. The UE may perform performance monitoring of these inactive models and report metrics, to the gNB, for possible LCM decisions by the gNB.

More specifically, models are registered/identified to the NW and have been assigned an ID. The UE has M_{active} models currently running for inference. The UE also has M_{inactive} models as candidate models. The inactive models may be indicated/signalled by the gNB. The gNB may also indicate, to the UE, which models in the inactive set UE are expected to do performance monitoring. The gNB may also indicate a performance metric type to be reported, e.g., an ID for SGCS, and/or an ID for minimized mean square error (MMSE).

After the IDs of the inactive models to be monitored have been indicated to the UE, the UE may report their metrics in a container in a CSI report, e.g., as a new CSI parameter. With a different type of reporting, the UE may indicate the IDs of the best K models with the largest (i.e., best) metrics, as well as their corresponding metrics. The metrics of the K models may be reported individually. Alternatively, a metric may be reported for the best model, and for the K−1 other models a differential metric relative to the best metric may be reported. K may be fixed in the specification or RRC configured to the UE by the gNB.

For monitoring inactive models, a UE should run the model for inference. Therefore, it is natural that the operation is counted towards AI/ML or legacy CPU budget. It is expected that the monitoring may take place less frequently than the actual CSI report. Therefore, a discount factor may be configured to the reports associated with monitoring inactive models.

For example:
If the reports of inactive models are configured as a CSI quantity within a CSI report configuration (functionality comigration), the CPU for that functionality may be counted larger than the case where the quantity is not configured. For example, monitoring inactive models may be counted as γ_{inactive} CPUs in addition to the γ_{active} CPUs counted for the original CSI report.
If the reports of inactive models are configured as separate CSI reports (functionality comigration), the CPU for that functionality may be counted as γ_{inactive} CPUs.

According to another embodiment, monitoring inactive models are not counted towards the CPU budget. This may be particularly relevant to a case where performance monitoring is done transparently by the UE, without informing the gNB and reporting metrics to the gNB. In such a case, the UE may provide a suggestion, to the gNB, about its preferred models to activate/switch. That is, a UE may suggest preferred models by reporting a list of inactive models with best performances to a gNB. The list may include a certain number of the set of inactive models that the UE is configured to monitor. For example, the gNB may configure a list of models with IDs 1, 2, 3, and 4 for the UE to monitor. The UE may report to the gNB that model 2 and 3 are suggested to become active. The gNB may then activate a suggested model after it receives the UE's report. The set of suggested models to the gNB may be transmitted as a CSI report in a PUCCH or PUSCH using legacy CSI report framework.

### Ground Truth CSI Reporting

In case a node that calculates a metric does not have access to a GT or a predicted/reconstructed CSI, the node may collect CSI from another node. For example, with a CSI compression use case, if a UE is calculating a metric and does not have access to a reconstructed CSI, which is available at a GNB side (e.g., output of the decoder model), the gNB may transmit a GT CSI to the UE for metric calculation. The GT CSI may be transmitted with higher accuracy for more exact metric calculation.

If a GT/predicted CSI is transmitted, from the UE, to the gNB, the gNB may trigger the GT/predicted CSI report via L1/L2 signaling and schedule an uplink channel or a GT/predicted CSI report, e.g., a PUCCH or PUSCH. If a GT/predicted CSI is transmitted, from the gNB, to the UE, the gNB may directly schedule a downlink channel and indicate a GT CSI transmission.

A quantization may be defined to map a GT/predicted CSI to a bit stream. For example, either a scalar quantization may be configured to the UE or vector quantization may be used. In case of a scalar quantization, the number of quantization levels, its intervals, and the associated bitmap to each interval are configured to the UE. In case of vector quantization, parameters of the vector quantizer are configured to the UE.

An association between a GT/predicted CSI and reference signals may also indicated by the gNB. For example, if a use case is an NW side CSI prediction, the gNB may configure a prediction window to the UE, even though UE does not perform inference, so that the UE knows which slots/CSI-RS instances it reports the GT-CSI for. In this case, the UE reports CSI for the observation window as a regular CSI report and CSI of the prediction window as GT CSI for the performance monitoring of the NW side model.

### Data Collection

### Signaling

Request by UE: Although data collection may be performed transparently by a UE, to speed up processes and match a CSI-RS pattern configuration, periodicity, etc., to the training and inference of an AI/ML model, the UE may send a request, to a gNB, to start transmission of a CSI-RS for data collection matching a specific training/inference scenario. For example, if the UE wants to train a prediction model for a window of N₄ slot intervals of length d, it may indicate, to the gNB, to start periodic CSI-RS transmissions matched for this training scenario. If the UE wants to train a model for beam prediction, it may indicate properties of the CSI-RS, e.g., indices of set B and set A, a number of ports, etc.

Data collection triggering/activation: Upon reception of a request from a UE, a gNB may trigger a data collection session by DCI, a MAC CE, or RRC configuration of a CSI report configuration.

CSI-RS for data collection: A gNB may configure a CSI report configuration dedicated to data collection. In this case, a UE does not report CSI for the configuration. Alternatively, the gNB may directly configure CSI-RS resource sets for the purpose of data collection, without any CSI report by the UE. The CSI-RS resources are expected to match a training scenario. In other words, for CSI prediction, CSI-RSs are transmitted with a periodicity of d slots and for a number of slot intervals which is at least N₄. For beam management, it is expected that CSI-RSs are transmitted according to conditions that a UE has requested, e.g., indices of set A and B.

### Assistance Information for Data Collection

Generally, data heterogeneity degrades performance of AI/ML models. In particular, if a single model is developed for a data set, which is mixture of different distributions, it is expected to perform worse than a model that is trained only for that distribution, when tested on that distribution. Therefore, ideally, a UE should train a model for each distribution of the test data.

For AI/ML CSI prediction, data input to a model is a CSI-RS channel measurement, e.g., an estimated channel matrix. The distribution of the channel matrices across sub-bands and time depends on channel properties, such as delay spread (affecting frequency domain correlation), Doppler spread (affecting time domain correlation), etc. Some of these parameters can be known at the UE side, and the UE can classify the data to different classes, train different models, and use a proper model in the inference phase. However, classifying the data to different distributions by the UE may not be an easy task, e.g., when a different distribution is due to different gNB implementations. For example, if a gNB uses different downlink beam codebooks, even for the same antenna configuration, channels measured by the UE may fall into different distributions. To ease a UE's task in developing distribution specific models for different gNB implementations, scenarios, etc., a gNB may indicate, to the UE, via an ID, which may be referred to as a data set ID, an additional condition ID or a scenario ID. Collected data with different IDs should fall into different distributions, and as such, a UE can develop different models for different IDs. A gNB can provide the ID in different ways.

gNB Vendor ID: A gNB may provide, to a UE, an ID that identifies a gNB vendor. A pool of gNB vendors may be considered offline, with each vendor assigned a unique ID. The indication to the UE may be in system information, CSI-RS/report configuration, or via a dedicated RRC parameter.

Additional condition ID: A gNB may configure CSI-RS resources/sets/reports with an additional ID that is expected to be associated with a specific gNB implementation. The gNB may or may not indicate, to a UE, which aspect of the gNB implementation the ID reflects. For example, if the gNB does indicate which aspect of the gNB implementation the ID reflects, the gNB can indicate that a unique ID is associated with a specific analog beam codebook.

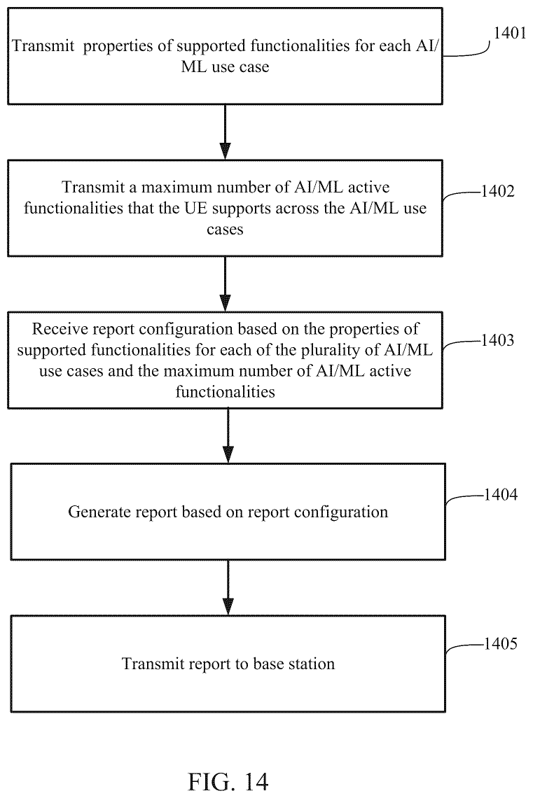

FIG. 14 is a flow chart illustrated a method performed by a UE, according to an embodiment.

Referring to FIG. 14, in step 1401, the UE, transmits, to a base station, properties of supported functionalities for each AI/ML use case. As described above, each of the AI/ML use cases may be configured with an individual use case ID.

In step 1402, the UE transmits, to the base station, a maximum number of AI/ML active functionalities that the UE supports across the AI/ML use cases.

In step 1403, the UE receives, from the based station, a report configuration based on the properties of supported functionalities for each of the AI/ML use cases and the maximum number of AI/ML active functionalities that the UE supports across the AI/ML use cases.

In step 1404, the UE generates a report based on the report configuration, and in step 1405, the UE transmits the report to the base station.

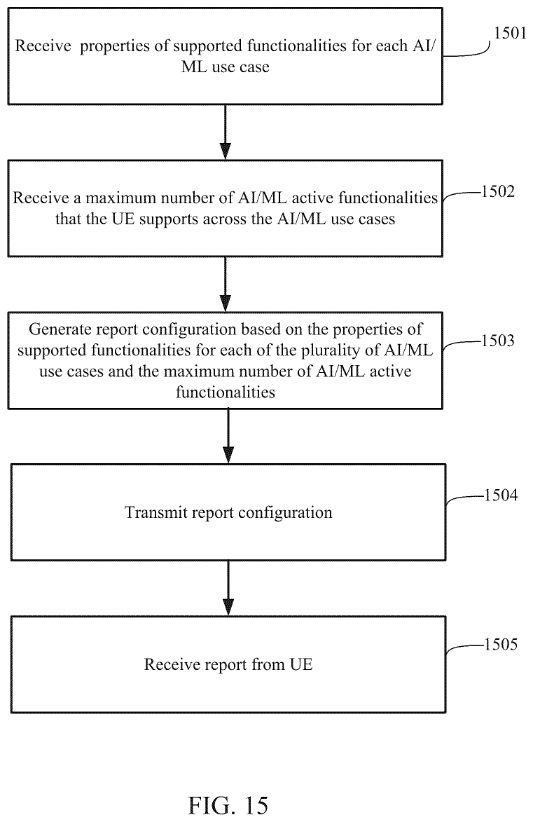

FIG. 15 is a flow chart illustrated a method performed by a base station, according to an embodiment.

Referring to FIG. 15, in step 1501, the base station receives, from a UE, properties of supported functionalities for each of a plurality of AI/ML use cases. As described above, each of the plurality of AI/ML use cases may be configured with an individual use case ID.

In step 1502, the base station receives, from the UE, a maximum number of AI/ML active functionalities that the UE supports across the plurality of AI/ML use cases.

In step 1503, the base station generates a report configuration based on the properties of supported functionalities for each of the plurality of AI/ML use cases and the maximum number of AI/ML active functionalities that the UE supports across the plurality of AI/ML use cases.

In step 1504, the base station transmits, to the UE, the report configuration.

In step 1505, the base station receives, from the UE, a report based on the report configuration.

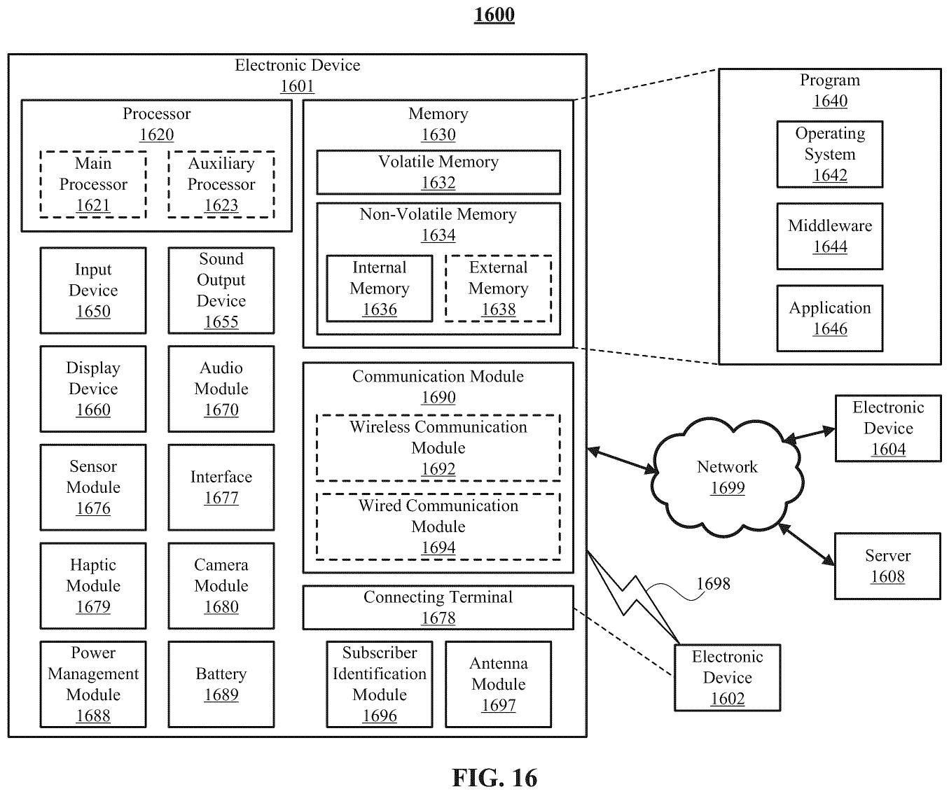

FIG. 16 is a block diagram of an electronic device in a network environment 1600, according to an embodiment.

Referring to FIG. 16, an electronic device 1601 in a network environment 1600 may communicate with an electronic device 1602 via a first network 1698 (e.g., a short-range wireless communication network), or an electronic device 1604 or a server 1608 via a second network 1699 (e.g., a long-range wireless communication network). The electronic device 1601 may communicate with the electronic device 1604 via the server 1608. The electronic device 1601 may include a processor 1620, a memory 1630, an input device 1650, a sound output device 1655, a display device 1660, an audio module 1670, a sensor module 1676, an interface 1677, a haptic module 1679, a camera module 1680, a power management module 1688, a battery 1689, a communication module 1690, a subscriber identification module (SIM) card 1696, or an antenna module 1697. In one embodiment, at least one (e.g., the display device 1660 or the camera module 1680) of the components may be omitted from the electronic device 1601, or one or more other components may be added to the electronic device 1601. Some of the components may be implemented as a single integrated circuit (IC). For example, the sensor module 1676 (e.g., a fingerprint sensor, an iris sensor, or an illuminance sensor) may be embedded in the display device 1660 (e.g., a display).

The processor 1620 may execute software (e.g., a program 1640) to control at least one other component (e.g., a hardware or a software component) of the electronic device 1601 coupled with the processor 1620 and may perform various data processing or computations, e.g., the method illustrated in FIG. 14.

As at least part of the data processing or computations, the processor 1620 may load a command or data received from another component (e.g., the sensor module 1676 or the communication module 1690) in volatile memory 1632, process the command or the data stored in the volatile memory 1632, and store resulting data in non-volatile memory 1634. The processor 1620 may include a main processor 1621 (e.g., a central processing unit or an application processor (AP)), and an auxiliary processor 1623 (e.g., a graphics processing unit (GPU), an image signal processor (ISP), a sensor hub processor, or a communication processor (CP)) that is operable independently from, or in conjunction with, the main processor 1621. Additionally or alternatively, the auxiliary processor 1623 may be adapted to consume less power than the main processor 1621, or execute a particular function. The auxiliary processor 1623 may be implemented as being separate from, or a part of, the main processor 1621.

The auxiliary processor 1623 may control at least some of the functions or states related to at least one component (e.g., the display device 1660, the sensor module 1676, or the communication module 1690) among the components of the electronic device 1601, instead of the main processor 1621 while the main processor 1621 is in an inactive (e.g., sleep) state, or together with the main processor 1621 while the main processor 1621 is in an active state (e.g., executing an application). The auxiliary processor 1623 (e.g., an image signal processor or a communication processor) may be implemented as part of another component (e.g., the camera module 1680 or the communication module 1690) functionally related to the auxiliary processor 1623.

The memory 1630 may store various data used by at least one component (e.g., the processor 1620 or the sensor module 1676) of the electronic device 1601. The various data may include, for example, software (e.g., the program 1640) and input data or output data for a command related thereto. The memory 1630 may include the volatile memory 1632 or the non-volatile memory 1634. Non-volatile memory 1634 may include internal memory 1636 and/or external memory 1638.

The program 1640 may be stored in the memory 1630 as software, and may include, for example, an operating system (OS) 1642, middleware 1644, or an application 1646.

The input device 1650 may receive a command or data to be used by another component (e.g., the processor 1620) of the electronic device 1601, from the outside (e.g., a user) of the electronic device 1601. The input device 1650 may include, for example, a microphone, a mouse, or a keyboard.

The sound output device 1655 may output sound signals to the outside of the electronic device 1601. The sound output device 1655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1660 may visually provide information to the outside (e.g., a user) of the electronic device 1601. The display device 1660 may include, for example, a display, a hologram device, or a projector and control circuitry to control a corresponding one of the display, hologram device, and projector. The display device 1660 may include touch circuitry adapted to detect a touch, or sensor circuitry (e.g., a pressure sensor) adapted to measure the intensity of force incurred by the touch.

The audio module 1670 may convert a sound into an electrical signal and vice versa. The audio module 1670 may obtain the sound via the input device 1650 or output the sound via the sound output device 1655 or a headphone of an external electronic device 1602 directly (e.g., wired) or wirelessly coupled with the electronic device 1601.

The sensor module 1676 may detect an operational state (e.g., power or temperature) of the electronic device 1601 or an environmental state (e.g., a state of a user) external to the electronic device 1601, and then generate an electrical signal or data value corresponding to the detected state. The sensor module 1676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1677 may support one or more specified protocols to be used for the electronic device 1601 to be coupled with the external electronic device 1602 directly (e.g., wired) or wirelessly. The interface 1677 may include, for example, a high-definition multimedia interface (HDMI), a universal serial bus (USB) interface, a secure digital (SD) card interface, or an audio interface.

A connecting terminal 1678 may include a connector via which the electronic device 1601 may be physically connected with the external electronic device 1602. The connecting terminal 1678 may include, for example, an HDMI connector, a USB connector, an SD card connector, or an audio connector (e.g., a headphone connector).

The haptic module 1679 may convert an electrical signal into a mechanical stimulus (e.g., a vibration or a movement) or an electrical stimulus which may be recognized by a user via tactile sensation or kinesthetic sensation. The haptic module 1679 may include, for example, a motor, a piezoelectric element, or an electrical stimulator.

The camera module 1680 may capture a still image or moving images. The camera module 1680 may include one or more lenses, image sensors, image signal processors, or flashes. The power management module 1688 may manage power supplied to the electronic device 1601. The power management module 1688 may be implemented as at least part of, for example, a power management integrated circuit (PMIC).

The battery 1689 may supply power to at least one component of the electronic device 1601. The battery 1689 may include, for example, a primary cell which is not rechargeable, a secondary cell which is rechargeable, or a fuel cell.

The communication module 1690 may support establishing a direct (e.g., wired) communication channel or a wireless communication channel between the electronic device 1601 and the external electronic device (e.g., the electronic device 1602, the electronic device 1604, or the server 1608) and performing communication via the established communication channel. The communication module 1690 may include one or more communication processors that are operable independently from the processor 1620 (e.g., the AP) and supports a direct (e.g., wired) communication or a wireless communication. The communication module 1690 may include a wireless communication module 1692 (e.g., a cellular communication module, a short-range wireless communication module, or a global navigation satellite system (GNSS) communication module) or a wired communication module 1694 (e.g., a local area network (LAN) communication module or a power line communication (PLC) module). A corresponding one of these communication modules may communicate with the external electronic device via the first network 1698 (e.g., a short-range communication network, such as BLUETOOTH™, wireless-fidelity (Wi-Fi) direct, or a standard of the Infrared Data Association (IrDA)) or the second network 1699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1692 may identify and authenticate the electronic device 1601 in a communication network, such as the first network 1698 or the second network 1699, using subscriber information (e.g., international mobile subscriber identity (IMSI)) stored in the subscriber identification module 1696.

The antenna module 1697 may transmit or receive a signal or power to or from the outside (e.g., the external electronic device) of the electronic device 1601. The antenna module 1697 may include one or more antennas, and, therefrom, at least one antenna appropriate for a communication scheme used in the communication network, such as the first network 1698 or the second network 1699, may be selected, for example, by the communication module 1690 (e.g., the wireless communication module 1692). The signal or the power may then be transmitted or received between the communication module 1690 and the external electronic device via the selected at least one antenna.

Commands or data may be transmitted or received between the electronic device 1601 and the external electronic device 1604 via the server 1608 coupled with the second network 1699. Each of the electronic devices 1602 and 1604 may be a device of a same type as, or a different type, from the electronic device 1601. All or some of operations to be executed at the electronic device 1601 may be executed at one or more of the external electronic devices 1602, 1604, or 1608. For example, if the electronic device 1601 should perform a function or a service automatically, or in response to a request from a user or another device, the electronic device 1601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1601. The electronic device 1601 may provide the outcome, with or without further processing of the outcome, as at least part of a reply to the request. To that end, a cloud computing, distributed computing, or client-server computing technology may be used, for example.

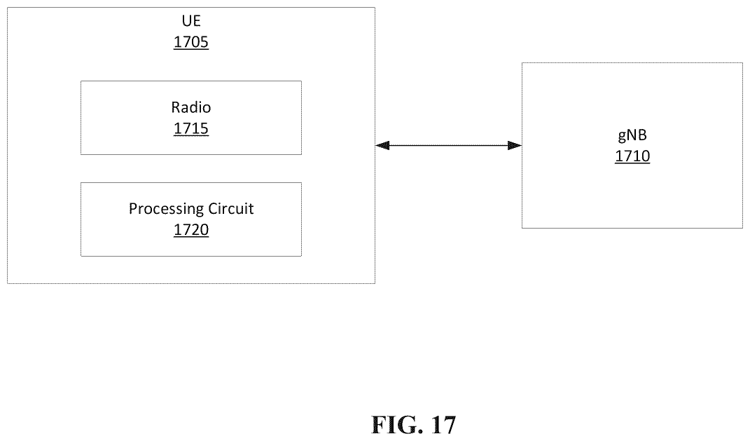

FIG. 17 shows a system including a UE 1705 and a gNB 1710, in communication with each other. The UE may include a radio 1715 and a processing circuit (or a means for processing) 1720, which may perform various methods disclosed herein, e.g., the method illustrated in FIG. 14. For example, the processing circuit 1720 may receive, via the radio 1715, transmissions from the network node (gNB) 1710, and the processing circuit 1720 may transmit, via the radio 1715, signals to the gNB 1710.

The methods for indicating restriction on the supported functionalities and number of models directly impacts UE complexity burden. Without such indication gNB may over configure AI/ML model workload at the UE. Similarly, for data collection, allowing UE to request the data collection helps mitigate the implementation complexity. Defining specific IDs for data collection allows for customized models for enhanced performance.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by a user equipment (UE), the method comprising:
transmitting, to a base station, a plurality of properties of supported functionalities for each of a plurality of artificial intelligence (AI)/machine leaning (ML) use cases, wherein each of the plurality of AI/ML use cases is configured with an individual use case identifier (ID);
transmitting, to the base station, a maximum number of AI/ML active functionalities that the UE supports across the plurality of AI/ML use cases;
receiving, from the based station, a report configuration based on the plurality of properties of supported functionalities for each of the plurality of AI/ML use cases and the maximum number of AI/ML active functionalities that the UE supports across the plurality of AI/ML use cases;
generating a report based on the report configuration; and
transmitting the report to the base station.

2. The method of claim 1, further comprising transmitting, to the base station, a maximum number of AI/ML active functionalities that the UE supports for each of the plurality of AI/ML use cases,
wherein the report configuration is further based on the maximum number of AI/ML active functionalities that the UE supports for each of the plurality of AI/ML use cases.

3. The method of claim 1, further comprising transmitting, to the base station, an indication of how activated, configured functionalities are counted by the UE,
wherein the report configuration is further based on how the activated, configured functionalities are counted by the UE.

4. The method of claim 3, wherein, for each use case ID, the indication includes a notification that the UE includes multiple models for one functionality.

5. The method of claim 3, wherein, for each use case ID, the indication includes a notification that the UE includes a single model for a group of configured functionalities.

6. The method of claim 1, wherein the plurality of properties of supported functionalities for each of the plurality of AI/ML use cases includes properties of different beam sets for an AI/ML beam prediction use case.

7. The method of claim 1, wherein the plurality of properties of supported functionalities for each of the plurality of AI/ML use cases includes properties of at least one of an observation window or a prediction window different beam sets for an AI/ML channel state information (CSI) report use case.

8. The method of claim 1, further comprising receiving, from the base station, an indication of inactive models.

9. The method of claim 8, further comprising receiving, from the base station, an indication of which of the inactive models for which the UE is to perform performance monitoring.

10. The method of claim 9, wherein the indication of which of the inactive models for which the UE is to perform the performance monitoring includes at least one model ID.

11. The method of claim 9, further comprising receiving, from the base station, an indication of a performance metric type with which the UE is to perform the performance monitoring of the inactive models.

12. The method of claim 11, wherein generating the report based on the report configuration comprises generating a channel state information (CSI) report including a performed metric corresponding to the performance metric type, based on the performance monitoring of the inactive models.

13. The method of claim 12, wherein the CSI report further includes indices of a predetermined number of best models and their corresponding monitored metrics.

14. The method of claim 12, wherein the CSI report is counted towards a CSI processing unit (CPU) limit.

15. The method of claim 14, therein the CPU limit is based on a UE capability or a predetermined value.

16. A user equipment (UE), comprising:
a transceiver; and
a processor configured to:
transmit, to a base station, via the transceiver, a plurality of properties of supported functionalities for each of a plurality of artificial intelligence (AI)/machine leaning (ML) use cases, wherein each of the plurality of AI/ML use cases is configured with an individual use case identifier (ID),
transmit, to the base station, via the transceiver, a maximum number of AI/ML active functionalities that the UE supports across the plurality of AI/ML use cases,
receive, from the based station, via the transceiver, a report configuration based on the plurality of properties of supported functionalities for each of the plurality of AI/ML use cases and the maximum number of AI/ML active functionalities that the UE supports across the plurality of AI/ML use cases,
generate a report based on the report configuration, and
transmit the report to the base station.

17. The UE of claim 16, wherein the processor is further configured to transmit, to the base station, via the transceiver, a maximum number of AI/ML active functionalities that the UE supports for each of the plurality of AI/ML use cases, and
wherein the report configuration is further based on the maximum number of AI/ML active functionalities that the UE supports for each of the plurality of AI/ML use cases.

18. The UE of claim 16, wherein the processor is further configured to transmit, to the base station, via the transceiver, an indication of how activated, configured functionalities are counted by the UE,
wherein the report configuration is further based on how the activated, configured functionalities are counted by the UE.

19. The UE of claim 16, wherein, for each use case ID, the indication includes:
a notification that the UE includes multiple models for one functionality, or a notification that the UE includes a single model for a group of configured functionalities.

20. A method performed by a base station, the method comprising:
receiving, from a user equipment (UE), a plurality of properties of supported functionalities for each of a plurality of artificial intelligence (AI)/machine leaning (ML) use cases, wherein each of the plurality of AI/ML use cases is configured with an individual use case identifier (ID);
receiving, from the UE, a maximum number of AI/ML active functionalities that the UE supports across the plurality of AI/ML use cases;
generating a report configuration based on the plurality of properties of supported functionalities for each of the plurality of AI/ML use cases and the maximum number of AI/ML active functionalities that the UE supports across the plurality of AI/ML use cases;
transmitting, to the UE, the report configuration; and
receiving, from the UE, a report based on the report configuration.
